(19) United States
(12) Patent Application Publication
(10) Pub. No.: US 2026/0032261 A1
(43) Pub. Date: Jan. 29, 2026

(54) POINT CLOUD ENCODING AND DECODING METHODS AND DECODER

(71) Applicant: GUANGDONG OPPO MOBILE TELECOMMUNICATIONS CORP., LTD., Dongguan (CN)

(72) Inventors: Fuzheng YANG, Dongguan (CN); Junyan HUO, Dongguan (CN); Yanzhuo MA, Dongguan (CN); Ming LI, Dongguan (CN)

(21) Appl. No.: 19/348,171

(22) Filed: Oct. 2, 2025

Related U.S. Application Data
(63) Continuation of application No. PCT/CN2023/089945, filed on Apr. 21, 2023.

(30) Foreign Application Priority Data
Apr. 18, 2023 (WO) PCT/CN2023/088956

(51) Int. Cl. H04N 19/159; H04N 19/13; H04N 19/172; H04N 19/597

(52) U.S. Cl. CPC H04N 19/159; H04N 19/13; H04N 19/172; H04N 19/597

(57) ABSTRACT

A decoder decodes a bitstream to determine first flag information corresponding to a current processing unit, where the first flag information is flag information corresponding to a sequence parameter set of a point cloud. The decoder further determines second flag information corresponding to the current processing unit according to the first flag information, where the second flag information is flag information corresponding to a geometry parameter set. The decoder further determines a probability model based on the second flag information, and obtains a prediction value of the current processing unit according to the probability model.

### CROSS-REFERENCE TO RELATED APPLICATION(S)

This application is a continuation of International Application No. PCT/CN2023/089945, filed Apr. 21, 2023, which claims priority to International Application No. PCT/CN2023/088956, filed Apr. 18, 2023, the entire disclosures of which are hereby incorporated by reference.

### TECHNICAL FIELD

Embodiments of the disclosure relate to the field of point cloud compression technology, and in particular to point cloud encoding and decoding methods and a decoder.

### BACKGROUND

Entropy coding is widely used in the encoding and decoding framework of geometry-based point cloud compression (G-PCC). Entropy coding is an encoding or decoding method that adaptively selects a probability model based on local context. When the local context of coding changes, a state of an encoder/decoder engine also changes. According to different contexts, the corresponding coding process is performed, which makes the probability model more effective during coding.

However, for the current entropy coding methods, there is a problem of high encoding and decoding complexity, which reduces the encoding and decoding performance of a point cloud.

### SUMMARY

In a first aspect, embodiments of the present disclosure provide a point cloud decoding method. The method is applied to a decoder and includes the following. A bitstream is decoded to determine first flag information corresponding to a current processing unit, where the first flag information is flag information corresponding to a sequence parameter set of a point cloud. Third flag information corresponding to the current processing unit is determined according to the first flag information, where the third flag information is flag information corresponding to geometry brick header information. A probability model corresponding to the current processing unit is determined based on the third flag information, and a prediction value of the current processing unit is obtained according to the probability model.

In a second aspect, embodiments of the present disclosure provide a point cloud encoding method. The method is applied to an encoder and includes the following. First flag information corresponding to a current processing unit is determined, and the first flag information is signalled into a bitstream, where the first flag information is flag information corresponding to a sequence parameter set of a point cloud. Third flag information corresponding to the current processing unit is determined according to the first flag information, and the third flag information is signalled into the bitstream, where the third flag information is flag information corresponding to geometry brick header information. A probability model corresponding to the current processing unit is determined based on the third flag information, and a prediction value of the current processing unit is obtained according to the probability model.

In a third aspect, embodiments of the present disclosure provide a decoder. The decoder includes a memory and a processor. The memory is configured to store a computer program executable by the processor. The processor is configured to perform the above-mentioned point cloud decoding method when executing the computer program.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1A illustrates a schematic diagram of a three-dimensional (3D) point cloud picture provided in an embodiment of the disclosure.

FIG. 1B illustrates a partial enlarged view of the 3D point cloud picture provided in an embodiment of the disclosure.

FIG. 2A illustrates a schematic diagram of a point cloud image from different viewing angles provided in an embodiment of the disclosure.

FIG. 2B illustrates a schematic diagram of a data storage format corresponding to FIG. 2A provided in an embodiment of the disclosure.

FIG. 3 illustrates a schematic diagram of a network architecture for point cloud encoding and decoding provided in an embodiment of the disclosure.

FIG. 4 illustrates a schematic diagram of a composition structure of a point cloud encoder provided in an embodiment of the disclosure.

FIG. 5 illustrates a schematic diagram of a composition structure of a point cloud decoder provided in an embodiment of the disclosure.

FIG. 6 illustrates a schematic diagram of a composition framework of a point cloud encoder.

FIG. 7 illustrates a schematic diagram of a composition framework of a point cloud decoder.

FIG. 8 illustrates a schematic diagram illustrating syntax of an entropy continuation flag.

FIG. 9 illustrates a schematic diagram of a setting process of entropy context.

FIG. 10 illustrates a schematic diagram of a process for determining an entropy model.

FIG. 11 illustrates a flowchart of using dependent entropy frames in TMC13.

FIG. 12 illustrates a schematic diagram of an implementation process of a point cloud decoding method provided in an embodiment of the disclosure.

FIG. 13 illustrates a schematic diagram of tile and slice partitioning provided in an embodiment of the disclosure.

FIG. 14 illustrates a first schematic diagram of a slice partitioning method provided in an embodiment of the disclosure.

FIG. 15 illustrates a second schematic diagram of a slice partitioning method provided in an embodiment of the disclosure.

FIG. 16 illustrates a third schematic diagram of a slice partitioning method provided in an embodiment of the disclosure.

FIG. 17 illustrates a schematic diagram of slice decoding.

FIG. 18 illustrates a schematic diagram of a bitstream structure.

FIG. 19 illustrates a schematic diagram of an implementation process of a point cloud encoding method provided in an embodiment of the disclosure.

FIG. 20 illustrates a first schematic diagram of a composition structure of an encoder.

FIG. 21 illustrates a second schematic diagram of a composition structure of an encoder.

FIG. 22 illustrates a first schematic diagram of a composition structure of a decoder.

FIG. 23 illustrates a second schematic diagram of a composition structure of a decoder.

### DETAILED DESCRIPTION

To enable a more detailed understanding of features and technical content in embodiments of the disclosure, the embodiments of the disclosure are described in detail below in conjunction with the accompanying drawings which are provided for illustrative purposes only and are not intended to limit the disclosure.

Unless otherwise defined, all technical and scientific terms used herein have the same meaning as commonly understood by those skilled in the art. The terms used herein are for the purpose of describing embodiments of the disclosure only and are not intended to limit the disclosure.

In the following description, reference to “some embodiments” describes a subset of all possible embodiments, but it is understood that “some embodiments” may refer to the same or different subsets of all possible embodiments and may be combined with each other without conflict. It is noted that the terms “first/second/third” in embodiments of the disclosure are merely for distinguishing similar objects and do not imply a particular ordering with respect to the objects, and it is understood that “first/second/third” may, where appropriate, be interchanged in a particular order or sequence so that embodiments of the disclosure described herein may be implemented in an order other than that illustrated or described herein.

A point cloud is a three-dimensional (3D) representation of a surface of an object. The point cloud (data) of the surface of the object may be captured by means of a capturing equipment such as a photo radar, a lidar, a laser scanner, and a multi-view camera.

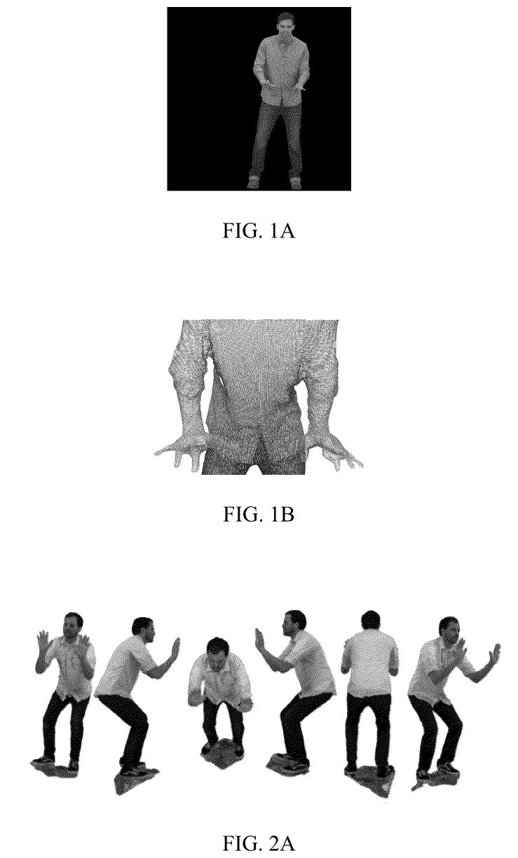

A point cloud is a set of discrete points irregularly distributed in space, which represent a spatial structure and surface attributes of a 3D object or scene. FIG. 1A illustrates a 3D point cloud picture and FIG. 1B illustrates a partial enlarged view of the 3D point cloud picture. As can be seen, the surface of the point cloud is composed of densely distributed points.

A 2D picture has information representation at each pixel point, and with regular distribution, there is no need to additionally record position information of each point. However, points in a point cloud have random and irregular distribution in 3D space, so a position of each point in space needs to be recorded to fully represent the point cloud. Similar to the 2D picture, each position has corresponding attribute information during the capture process, which is usually an RGB color value(s) that reflects a color of an object. For the point cloud, in addition to color information, the attribute information corresponding to each point often contains a reflectance value, which reflects a surface material of the object. Therefore, a point in the point cloud may contain the position information and the attribute information of the point. For example, the position information of the point may be 3D coordinate information (x, y, z) of the point. The position information of the point may also be referred to as geometry information of the point. For example, the attribute information of the point may include color information (3D color information) and/or reflectance (1D reflectance information r), etc. For example, the color information may be information in any color space. For example, the color information may be RGB information, where R represents red, G represents green, and B represents blue. For another example, the color information may be luminance-chrominance (YCbCr, YUV) information, where Y represents luminance, Cb (U) represents blue chrominance, and Cr (V) represents red chrominance.

For a point cloud acquired based on laser measurement, points in the point cloud may contain 3D coordinate information of the points and reflectance values of the points. For another example, for a point cloud acquired based on photogrammetry, points in the point cloud may contain 3D coordinate information of the points and 3D color information of the points. For another example, for a point cloud acquired based on the laser measurement in combination with the photogrammetry, points in the point cloud may contain the 3D coordinate information of the points, the reflectance values of the points, and the 3D color information of the points.

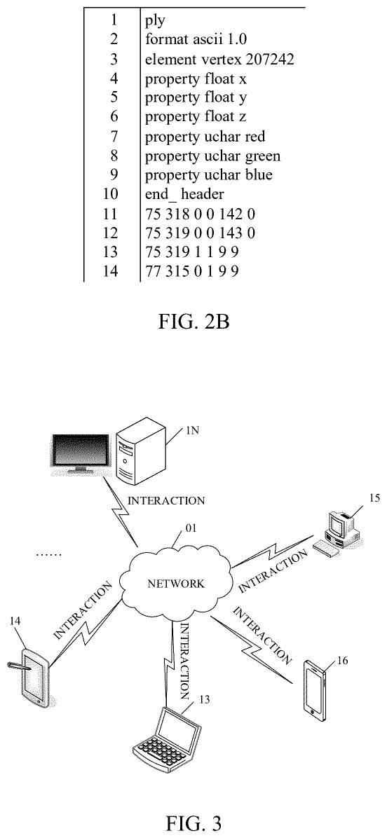

FIG. 2A and FIG. 2B illustrate a point cloud picture and a corresponding data storage format of the point cloud picture. FIG. 2A provides the point cloud picture from six viewing angles. FIG. 2B consists of a file header information part and a data part. The header information contains a data format, a data representation type, a total number of points in the point cloud, and content represented by the point cloud. For example, the point cloud is in the “.ply” format, represented by ASCII code, with a total of 207,242 points, and each point has 3D coordinate information (x, y, z) and 3D color information (r, g, b).

According to the acquisition manners, point clouds can be classified as:
Static point cloud: that is, an object is stationary, and a device for acquiring the point cloud is also stationary.
Dynamic point cloud: that is, the object is in motion, but the device for acquiring the point cloud is stationary.
Dynamic acquisition point cloud: that is, the device for acquiring the point cloud is in motion.

For example, point clouds can be classified into category 1 and category 2 according to usage:
category 1: machine-perception point cloud, which can be used in scenarios such as an autonomous navigation system, a real-time inspection system, a geographic information system, a visual sorting robot, and a rescue and disaster relief robot.
category 2: human-eye-perception point cloud, which can be used in point cloud application scenarios such as digital cultural heritage, free-viewpoint broadcasting, 3D immersive communication, and 3D immersive interaction.

The point cloud can flexibly and conveniently represent a spatial structure and a surface attribute of a 3D object or scene. In addition, since the point cloud is acquired by directly sampling a real object, a strong sense of realism can be provided on a premise of ensuring accuracy. Thus the point cloud has a wide range of applications, including a virtual reality game, a computer-aided design, a geographic information system, an automatic navigation system, digital cultural heritage, free-viewpoint broadcasting, 3D immersive telepresence, and 3D reconstruction of a biological tissue and organ.

Point clouds are mainly captured through the following approaches: computer generation, 3D laser scanning, 3D photogrammetry, etc. A computer can generate a point cloud of a virtual 3D object and scene. 3D laser scanning can acquire a point cloud of a static 3D object or scene in the real world, with millions of points acquired per second. 3D photogrammetry can acquire a point cloud of a dynamic 3D object or scene in the real world, with tens of millions of points acquired per second. The technologies reduce the cost and time for acquiring point cloud data and improved the accuracy of data. The revolution in point cloud data acquisition makes it possible to acquire a large amount of point cloud data. With the growth of application demands, the processing of massive 3D point cloud data is encountering bottlenecks in storage space and transmission bandwidth.

Exemplarily, for a point cloud video with a frame rate of 30 frames per second (fps), each frame of the point cloud contains 700,000 points, and each point has coordinate information xyz (float) and color information RGB (uchar). A data volume of a 10-second point cloud video is approximately 0.7 million×(4 Byte×3+1 Byte×3)×30 fps×10 s=3.15 GB, where 1 Byte=8 bit. For a 1280×720 2D video with a YUV sampling format of 4:2:0 and a frame rate of 24 fps, a data volume for 10 seconds is approximately 1280×720×12 bits×24 frames×10 s≈0.33 GB. A data volume of a 10-second two-view 3D video is approximately 0.33×2=0.66 GB. It can be seen that the data volume of the point cloud video is much larger than data volumes of a 2D video and a 3D video with the same duration. Therefore, to better realize data management, save server storage space, and reduce transmission traffic and transmission time between a server and a client, point cloud compression becomes a key issue to promote development of the point cloud industry.

That is to say, since the point cloud is a collection of massive points, storing the point cloud not only consumes a large amount of memory but also is not conducive to transmission. Moreover, there is no such large bandwidth to support a direct transmission of the point cloud without compression at the network layer. Therefore, the point cloud needs to be compressed.

Currently, point cloud coding frameworks that can compress the point cloud may be either a geometry-based point cloud compression (G-PCC) coding framework or a video-based point cloud compression (V-PCC) coding framework provided by the moving picture experts group (MPEG), or the audio video standard (AVS)-PCC coding framework provided by the AVS. The G-PCC coding framework may be used for compression of the first-category static point cloud and the third-category dynamic acquisition point cloud, and the V-PCC coding framework may be used for compression of the second-category dynamic point cloud.

Embodiments of the disclosure provide a network architecture of a point cloud coding system including a point cloud decoding method and a point cloud encoding method. FIG. 3 illustrates a schematic diagram of a network architecture for point cloud coding provided in an embodiment of the disclosure. As illustrated in FIG. 3, the network architecture includes one or more electronic devices 13 to 1N and a communication network 01, where the electronic devices 13 to IN can perform video interaction through the communication network 01. During implementation, the electronic devices may be various types of devices with a point cloud coding function. For example, the electronic device may include a mobile phone, a tablet computer, a personal computer, a personal digital assistant, a navigator, a digital phone, a video phone, a television, a sensing device, and a server, etc., which is not limited in embodiments of the disclosure. A decoder or encoder in embodiments of the disclosure may be the above-mentioned electronic device.

The electronic device in embodiments of the disclosure has a point cloud coding function, and generally contains a point cloud encoder (i.e., encoder) and a point cloud decoder (i.e., decoder).

A point cloud compression technology is described below by taking an coding framework as an example.

It can be understood that point cloud compression generally employs separate compression of geometry information and attribute information of a point cloud. At an encoding end, the geometry information of the point cloud is first encoded in a geometry encoder, and then reconstructed geometry information is input as additional information into an attribute encoder to assist in compression of a point cloud attribute(s). At a decoding end, the geometry information of the point cloud is first decoded in a geometry decoder, and then decoded geometry information is input as additional information into an attribute decoder to assist in decompression of the point cloud attribute. The whole codec consists of preprocessing/post-processing, geometry encoding/decoding, and attribute encoding/decoding.

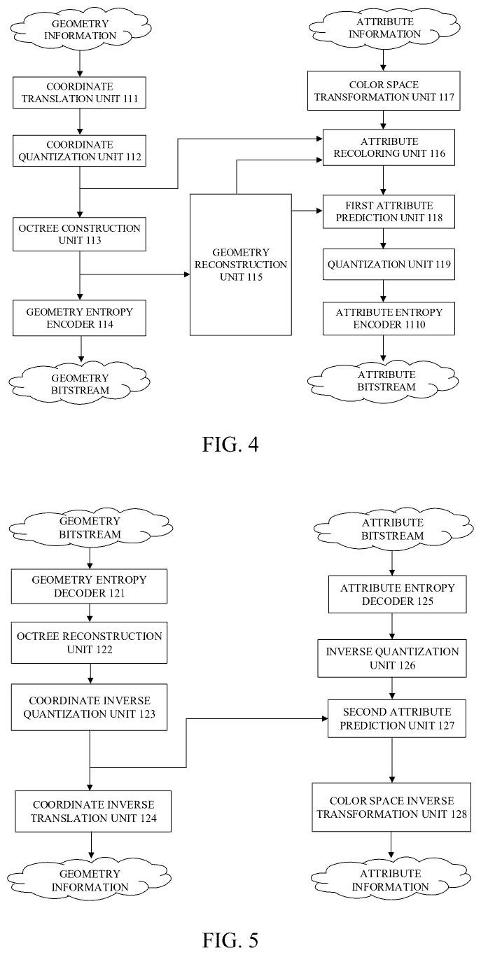

Embodiments of the disclosure provide a point cloud encoder. FIG. 4 illustrates a reference framework for point cloud compression. A point cloud encoder 11 includes a geometry encoder and an attribute encoder. The geometry encoder includes a coordinate translation unit 111, a coordinate quantization unit 112, an octree construction unit 113, a geometry entropy encoder 114, and a geometry reconstruction unit 115. The attribute encoder includes an attribute recoloring unit 116, a color space transformation unit 117, a first attribute prediction unit 118, a quantization unit 119, and an attribute entropy encoder 1110.

In a geometry encoding part at the encoding end, preprocessing is first performed on original geometry information. A geometry origin is normalized by the coordinate translation unit 111 to a position of the minimum value in a point cloud space, and geometry information is converted by the coordinate quantization unit 112 from floating-point numbers to integers to facilitate subsequent regularization processing. Then, geometry encoding is performed on regularized geometry information. The point cloud space is recursively subdivided by the octree construction unit 113 using an octree structure, in which a current node is divided into eight sub-blocks of equal size each time, and the occupancy of each sub-block is determined. A sub-block containing no point is marked as empty; otherwise, the sub-block is marked as non-empty. At the last layer of recursive subdivision, occupancy information of all blocks is recorded and subjected to geometry encoding. Geometry information represented by the octree structure is input into the geometry entropy encoder 114 to form a geometry bitstream. Further, the geometry information is input into in the geometry reconstruction unit 115 for geometry reconstruction. Reconstructed geometry information is input as additional information into the attribute encoder.

In an attribute encoding part, preprocessing is first performed on original attribute information. Since the geometry information is changed after the geometry encoding, an attribute value is reassigned to each point by the attribute recoloring unit 116 after the geometry encoding, thus realizing attribute recoloring. In addition, if attribute information to be processed is color information, original color information is subjected to color space transformation by the color space transformation unit 117 to transform into a YUV color space that is more in line with human visual characteristics. Then, attribute encoding is performed on the preprocessed attribute information by the first attribute prediction unit 118. For the attribute encoding, the point cloud first needs to be reordered using Morton code, thus a traversal order of the attribute encoding is Morton order. An attribute prediction manner is single-point prediction based on Morton order. That is, based on the Morton order, one point is traced back from a current point (current node) to be encoded, and the found node is used as a prediction reference point for the current point to be encoded. A reconstructed attribute value of the prediction reference point is used as an attribute prediction value for the current point, and an attribute residual value is obtained as a difference between an original attribute value of the current point to be encoded and the attribute prediction value. Finally, the attribute residual value is quantized by the quantization unit 119, and quantized residual information is input into the attribute entropy encoder 1110 to form an attribute bitstream.

Embodiments of the disclosure further provide a point cloud decoder. FIG. 5 illustrates a schematic diagram of a composition structure of the point cloud decoder provided in an embodiment of the disclosure. FIG. 5 illustrates a reference framework for point cloud decompression. A point cloud decoder 12 includes a geometry decoder and an attribute decoder. The geometry decoder includes a geometry entropy decoder 121, an octree reconstruction unit 122, a coordinate inverse quantization unit 123, and a coordinate inverse translation unit 124. The attribute decoder includes an attribute entropy decoder 125, an inverse quantization unit 126, a second attribute prediction unit 127, and a color space inverse transformation unit 128.

At the decoding end, geometry decoding and attribute decoding are also performed separately. In the geometry decoding part, entropy decoding is first performed on the geometry bitstream by the geometry entropy decoder 121 to obtain geometry information of each node. Then, an octree structure is constructed in the same way as in geometry encoding by the octree reconstruction unit 122. In combination with the decoded geometry, geometry information represented by the octree structure after coordinate transformation is reconstructed. The information is subjected to coordinate inverse quantization by the coordinate inverse quantization unit 123 and inverse translation by the coordinate inverse translation unit 124, to obtain decoded geometry information. Additionally, the information is input as additional information into the attribute decoder. In the attribute decoding part, a Morton order is constructed in the same way as at the encoding end. Entropy decoding is first performed on the attribute bitstream by the attribute entropy decoder 125 to obtain quantized residual information. Then, inverse quantization is performed by the inverse quantization unit 126 to obtain an attribute residual value. Similarly, an attribute prediction value of a current point to be decoded is obtained by the second attribute prediction unit 127 in the same way as in attribute encoding. The attribute prediction value is then added to the attribute residual value to obtain a reconstructed attribute value (e.g., YUV attribute value) of the current point to be decoded. Finally, color space inverse transformation is performed by the color space inverse transformation unit 128 to obtain decoded attribute information.

It can also be understood that, the coding framework may be based on Pred, Predtrans-resource-constrained, Predtrans-resource-unconstrained, or Trans.

There are four general test conditions, specifically including:
condition 1: near-lossy geometry position and lossy attributes;
condition 2: lossless geometry position and lossy attributes;
condition 3: lossless geometry position and near-lossy attributes; and
condition 4: lossless geometry position and lossless attributes.

There are 4 technical routes, distinguished by the algorithm used for attribute compression.

Technical route 1: Pred (prediction) branch, where the attribute compression adopts a manner based on intra prediction.

At an encoding end, points in a point cloud are processed in a certain order (an original point cloud capture order, a Morton order, or a Hilbert order, etc.). First, a prediction algorithm is used for obtaining an attribute prediction value, an attribute residual is obtained based on an attribute value and the attribute prediction value, then the attribute residual is quantized to generate a quantized residual, and finally the quantized residual is encoded.

At a decoding end, points in the point cloud are processed in the certain order (the original point cloud capture order, the Morton order, or the Hilbert order, etc.). First, the prediction algorithm is used for obtaining the attribute prediction value, then the quantized residual is obtained through decoding, the quantized residual is inversely quantized, and finally a reconstructed attribute value is obtained based on the attribute prediction value and an inversely quantized residual.

Technical route 2: based on Predtrans-resource-constrained (based on prediction-transformation branch and resource constrained), where the attribute compression adopts a manner based on intra prediction and k-ary discrete cosine transform (DCT). When encoding quantized transform coefficients, there is a limit on the maximum number X of points (e.g., 4096), that is, encoding is performed in a group of at most X points.

At an encoding end, points in a point cloud are processed in a certain order (an original point cloud capture order, a Morton order, or a Hilbert order, etc.). First, the whole point cloud is divided into several small groups with a maximum length of Y (e.g., 2), then the several small groups are combined into several large groups (the number of points in each large group does not exceed X, e.g., 4096). After that, a prediction algorithm is used for obtaining an attribute prediction value, and an attribute residual is obtained based on an attribute value and the attribute prediction value. DCT is performed on the attribute residuals in unit of a small group to generate transform coefficients, the transform coefficients are quantized to generate quantized transform coefficients, and finally the quantized transform coefficients are encoded in unit of a large group.

At a decoding end, points in the point cloud are processed in the specific order (such as the original point cloud capture order, the Morton order, or the Hilbert order, etc.). First, the entire point cloud is divided into several small groups with the maximum length of Y (e.g., 2), and then the small groups are combined into several large groups (the number of points in each large group does not exceed X, e.g., 4096). The quantized transform coefficients are obtained by decoding in unit of a large group. Then, the prediction algorithm is used for obtaining the attribute prediction value. After that, inverse quantization and inverse transformation are performed on the quantized transform coefficients in unit of a small group. Finally, the reconstructed attribute value is obtained based on the attribute prediction value and the coefficient after inverse quantization and inverse transformation.

Technical route 3: based on Predtrans-resource-unconstrained (based on prediction-transformation branch and resource unconstrained), where the attribute compression adopts a manner based on intra prediction and DCT. When encoding quantized transform coefficients, there is no limit on the maximum number X of points, that is, all coefficients are encoded together.

At an encoding end, points in the point cloud are processed in a specific order (such as an original point cloud capture order, a Morton order, or a Hilbert order, etc.). First, the whole point cloud is divided into several small groups with a maximum length of Y (e.g., 2). Then, a prediction algorithm is used for obtaining an attribute prediction value, and an attribute residual is obtained based on an attribute value and the attribute prediction value. DCT is performed on the attribute residuals in unit of a small group to generate transform coefficients, the transform coefficients are then quantized to generate quantized transform coefficients. Finally, the quantized transform coefficients of the whole point cloud are encoded.

At a decoding end, points in the point cloud are processed in the specific order (such as the original point cloud capture order, the Morton order, or the Hilbert order, etc.). First, the whole point cloud is divided into several small groups with the maximum length of Y (e.g., 2). The quantized transform coefficients of the whole point cloud are obtained by decoding. Then, the prediction algorithm is used for obtaining the attribute prediction value. After that, inverse quantization and inverse transformation are performed on the quantized transform coefficients in unit of a small group. Finally, the reconstructed attribute value is obtained based on the attribute prediction value and the coefficient after inverse quantization and inverse transformation.

Technical route 4: based on Trans branch (multi-layer transformation branch), where the attribute compression adopts a manner based on multi-layer wavelet transformation.

At an encoding end, multi-layer wavelet transformation is performed on a whole point cloud to generate transform coefficients. The transform coefficients are then quantized to generate quantized transform coefficients. Finally, the quantized transform coefficients of the entire point cloud are encoded.

At a decoding end, the quantized transform coefficients of the whole point cloud are obtained by decoding. Then, inverse quantization and inverse transformation are performed on the quantized transform coefficients to obtain reconstructed attribute values.

In technical route 1, the coefficient may be the quantized residual. In the above-mentioned technical routes 2, 3, and 4, the coefficient may be the quantized transform coefficient.

It can be seen that, at the encoding/decoding end, there is no solution for encoding and decoding by adaptively selecting a context mode.

The point cloud compression technology is described below by taking an attribute coding framework as an example.

In a point cloud encoder framework, geometry information of a point cloud and attribute information corresponding to each point are encoded separately. Current reference-attribute encoding frameworks can be classified as a Pred-based branch, a PredLift-based branch, and a RAHT-based branch.

The point cloud compression technology is described below by taking the G-PCC coding framework as an example.

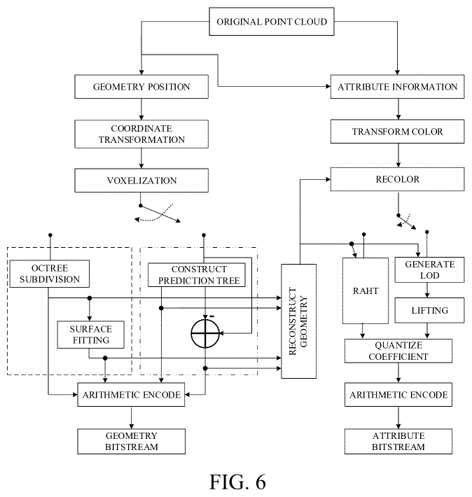

FIG. 6 illustrates a schematic diagram of a composition framework of a point cloud encoder. As illustrated in FIG. 6, during geometry encoding, coordinate transformation is performed on geometry information to ensure all points of the point cloud are contained within a bounding box. Then, quantization is performed, which mainly serves a purpose of scaling. Due to rounding in quantization, the geometry information of some points in the point cloud becomes identical. Next, whether to remove a duplicate point(s) is determined based on a parameter(s). The process of quantization and duplicate point removal is also referred to as a voxelization process. Subsequently, octree subdivision or prediction tree construction is performed on the bounding box. In the process, arithmetic encoding is performed on a point in a partitioned leaf node to generate a binary geometry bitstream. Alternatively, arithmetic encoding is performed on a vertex generated by subdivision (surface fitting based on vertices), to generate a binary geometry bitstream. During attribute encoding, after the completion of geometry encoding and reconstruction of the geometry information, color transformation needs to be performed first to transform color information (i.e., attribute information) from RGB color space to YUV color space. Then, reconstructed geometry information is used for recoloring the point cloud, so that unencoded attribute information corresponds to the reconstructed geometry information. Attribute encoding is mainly performed on color information. During color information encoding, there are two main transform methods: one is a distance-based lifting transform dependent on level of detail (LOD) partitioning, and the other is a direct region adaptive hierarchical transform (RAHT). Both methods transform the color information from a spatial domain to a frequency domain. High-frequency coefficients and low-frequency coefficients are obtained through transformation. Finally, the coefficients are quantized, and the arithmetic encoding is performed on quantized coefficients to generate a binary attribute bitstream.

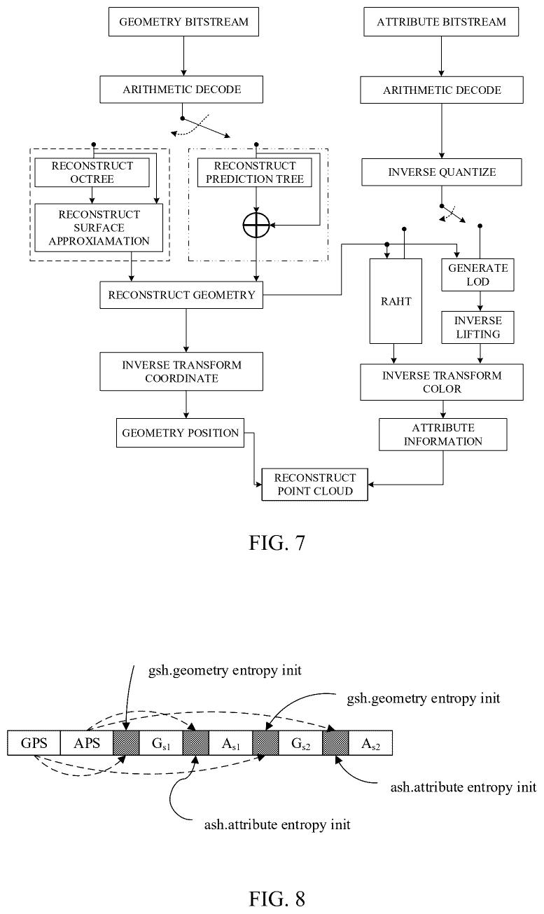

FIG. 7 illustrates a schematic diagram of a composition framework of a point cloud decoder. As illustrated in FIG. 7, for an obtained binary bitstream, a geometry bitstream and an attribute bitstream within the binary bitstream are first decoded independently. When decoding the geometry bitstream, geometry information of the point cloud is obtained through arithmetic decoding, octree reconstruction/prediction tree reconstruction, geometry reconstruction, and coordinate inverse transformation. When decoding the attribute bitstream, attribute information of the point cloud is obtained through arithmetic decoding, inverse quantization, LOD partitioning/RAHT, and color inverse transformation. Point cloud data to be encoded (i.e., output point cloud) is reconstructed based on the geometry information and the attribute information.

It should be noted that, as illustrated in FIG. 6 or FIG. 7, in the point cloud G-PCC codec framework, current point cloud geometry coding can be classified as octree geometry coding (marked with a dashed box), prediction tree-based geometry coding (marked with a dash-dot box), and Trisoup-based geometry coding.

For octree geometry encoding (OctGeomEnc), the following steps are included. First, coordinate transformation is performed on geometry information to ensure all points of a point cloud are contained within a bounding box determined by two extreme points (0, 0, 0) and (2d, 2d, 2d). Then, voxelization is performed, which includes quantization, rounding, and duplicate point removal (determined based on parameters). Next, octree subdivision is successively performed on non-empty sub-cubes (containing a point(s) of the point cloud) in the bounding box in a breadth-first traversal order. At the same octree depth, a node is divided into 8 sub-nodes, and the subdivision stops when the obtained leaf nodes are 1× 1×1 unit cubes. The 8-bits binary code generated based on whether a sub-cube is occupied by a point (1 for occupied, 0 for unoccupied) is called an occupancy code. Encoding is performed on the occupancy code of each node to generate a binary bitstream.

Octree geometry decoding includes the following steps. In the breadth-first traversal order, the occupancy code of each node is parsed out successively, and nodes are recursively subdivided until the subdivided nodes are 1×1×1 unit cubes. The number of points contained in each leaf node is parsed out, and finally, geometry reconstructed point cloud information is obtained.

For Trisoup-based geometry coding, the following steps are included. First, octree subdivision is performed. Different from octree geometry information encoding, this method does not require gradual subdivision of the point cloud into bottom-level leaf nodes with side lengths of 1×1×1. Instead, the Trisoup-based geometry encoding partitions the point cloud into leaf nodes with a specified side length. Then, surface information formed by voxels in the leaf nodes is represented by a series of triangle meshes. In G-PCC, a parameter “trisoup node size” is used to represent a size of a block containing triangles. When the trisoup node size is greater than 0, a geometry patch is used for representing a voxel set in a node. Up to twelve intersection points generated by the geometry patch and twelve edges of the block are called vertices. Vertex coordinates of each block are encoded in sequence to generate a binary bitstream.

Trisoup-based geometry decoding includes the following steps. To recover geometry coordinates of the point cloud from the triangular patch of the node, whether each voxel in the node cube intersects with the triangle patch needs to be tested. The technology is called triangle rasterization. Six unit vectors (0, 0, 1), (0, 0, 1), (0, 0, 1), (0, 0, 1), (0, 0, 1), (0, 0, 1) are used for intersection test to check whether each unit vector intersects with the triangular patch. If an intersection exists, an intersection point is calculated and a decoded cube is output. The number of points generated in the decoder is determined by a mesh distance.

For prediction tree-based geometry coding, the following steps are included. First, the input point cloud is sorted. The sorting manners currently employed include unordered, a Morton order, an azimuth order, and a radial distance order. At an encoding end, a prediction tree structure is established in two different manners: a high-latency slow mode (KD-Tree) and a low-latency fast mode that uses LiDAR calibration information to divide each point into different lasers and establishes a prediction structure based on different lasers. Next, based on the structure of the prediction tree, each node in the prediction tree is traversed. Different prediction modes are selected to predict geometry position information of the node to obtain a prediction residual, and a quantization parameter is used for quantizing the geometry prediction residual. Finally, through successively iteration, the prediction residuals of the position information of the nodes in the prediction tree, the prediction tree structure, and the quantization parameter are encoded to generate a binary bitstream.

Prediction tree-based geometry decoding includes the following steps. A decoding end successively parses a bitstream to reconstruct the prediction tree structure. Then, geometry position prediction residual information and the quantization parameter of each prediction node are obtained through parsing, inverse quantization is performed on the prediction residual to obtain reconstructed geometry position information of each node. Finally, geometry reconstruction at the decoding end is completed.

Currently, entropy coding is widely used in G-PCC. Entropy coding is an encoding or decoding method that adaptively selects a probability model based on local context. When the local context of coding changes, the state of an encoder/decoder engine also changes. According to different contexts, the corresponding encoding process is performed, which makes the probability model more effective during coding.

For parallel coding, coding is performed from one slice to another. At an end of each slice, a process reinitializes the state of the engine to a default value to achieve parallelism. For multi-core processing, continuation of the context table is impossible, so the context table needs to be initialized to the default value. Ideally, each slice unit should be independent of each other. If slices are implemented for data partitioning in low-latency applications rather than for parallelism in multi-core processing, initialization of the entropy context table will lead to decrease in coding performance. The reason is that a probability model needs to start from the default value instead of continuing from a probability model with a good prediction performance. Therefore, an entropy context continuation flag can help come into play, which can save the context probability table at the end of a slice and configure using the same context probability table when the next slice begins. The manner can improve the coding performance of slices. The decoder needs a similar implementation to save the context table probability value at the end of the slice and set it as an initial context table probability value for a new slice.

FIG. 8 illustrates a schematic diagram of a syntax of an entropy continuation flag. As illustrated in FIG. 8, the G-PCC software specification introduces a manner for initializing or inheriting context based on slice-partition-framework, and signals/reads the entropy_continuation_flag parameter during encoding and decoding. The context_continuation_flag can be controlled independently for each slice. Separate parameters are used for saving and setting a context table for geometry and a context table for attribute respectively. Separation of the entropy continuation flags for geometry and attribute allows users to control and generate a G-PCC bitstream with a higher compression ratio. The geometry entropy_continuation_flag is placed in the geometry data unit header (GSH), while the attribute entropy_continuation_flag is placed in the attribute data unit header (ASH).

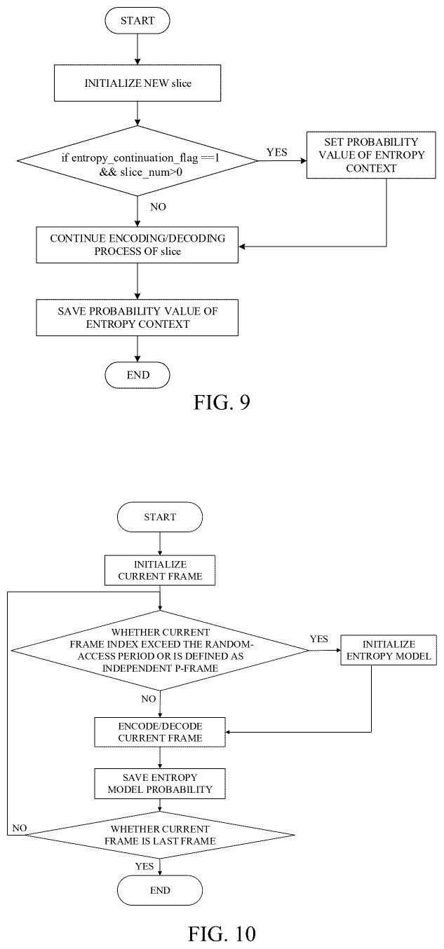

FIG. 9 illustrates a schematic diagram of an entropy context setting process. As illustrated in FIG. 9, at the start of slice encoding, if entropy_continuation_flag is set to 0 and slice number is greater than 0 (not the first slice), a context table probability value will be set to a previously saved value. At the end of slice encoding, that is, before exiting slice encoding, the context table probability value is saved. At the start of slice decoding, if a condition(s) is satisfied, the context table probability value is loaded. At the end of slice decoding, the entropy context table probability value is saved.

In the MPEG G-PCC standard, the syntax table of the GSH defines the semantics related to entropy continuation between slices as illustrated in Table 1.

TABLE 1

| | Descriptor |
|---|---|
| geometry_data_unit_header( ) { | |
| gdu_geometry_parameter_set_id | u(4) |
| gdu_reserved_zero_3bits | u(3) |
| slice_id | ue(v) |
| slice_tag | u(v) |
| frame_ctr_lsb | u(v) |
| if(entropy_continuation_enabled) { | |
| slice_entropy_continuation | u(1) |
| if(slice_entropy_continuation) | |
| prev_slice_id | ue(v) |
| } | |

The definitions of the descriptors are as follows: ae(v): adaptive arithmetic entropy coding syntax element; se(v): signed integer 0th-order exponential-Golomb coding syntax element; u (n): n-bit unsigned integer, if written as u(v), it means the number of bits varies depending on a value of another syntax element; and ue(v): unsigned integer 0th-order exponential-Golomb coding syntax element.

In G-PCC intra coding, a slice entropy continuation method is adopted. In inter encoding, each frame is associated with global/local motion and inter occupancy prediction. FIG. 10 illustrates a schematic diagram of a process for determining an entropy model. As illustrated in FIG. 10, after initializing a current frame, whether a current frame index exceeds the random-access period or is defined as an independent P-frame is determined. If a determination result is yes, the entropy model is initialized. If not, the current frame is encoded/decoded, then an entropy model probability is saved. Finally, whether the current frame is the last frame is determined. If a determination result is yes, the process ends. If not, the process returns to the step of determining whether the current frame index exceeds the random-access period or is defined as the independent P-frame.

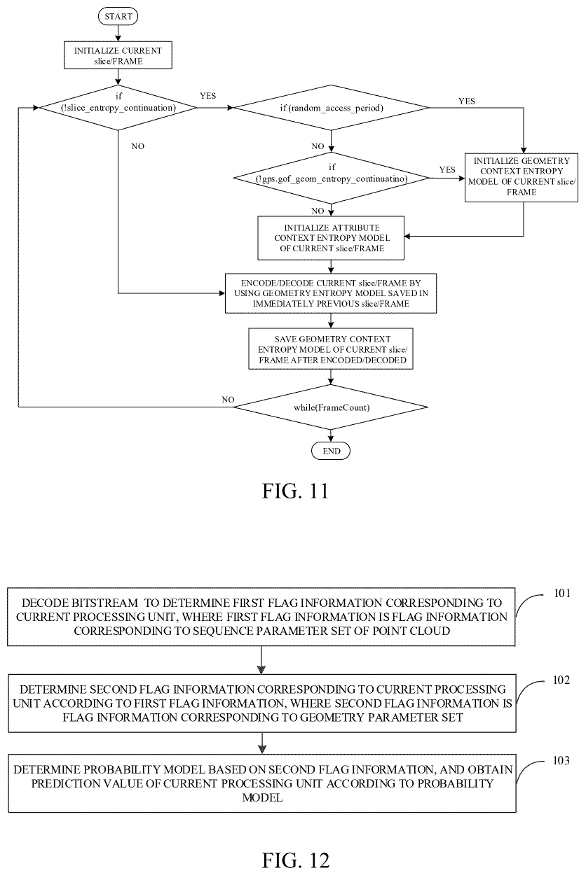

FIG. 11 illustrates a flowchart of using a dependent entropy frame in TMC13. As illustrated in FIG. 11, a scheme for enabling/disabling entropy continuation between slices and between frames may be as follows. After initializing a current frame, whether entropy continuation between slices is enabled for the current frame is determined firstly. Then it is determined whether entropy continuation between frames is enabled. Based on an enabling status of entropy continuation, it is decided whether to reinitialize an entropy model for the current slice/frame or inherit a previously-saved entropy model of a slice/frame.

If entropy continuation between slices is disabled (firstSliceInFrame: =1, which means the current slice is the first slice of the current frame), the flag entropyContinuationEnabled is set to 0. In this case, whether the current frame is an independent encoding/decoding frame (I-frame) in a random-access period (randomAccessPeriod) needs to be determined. If the current frame is the independent encoding/decoding frame (I-frame) or a P-frame with inter continuation disabled (GoFGeometryEntropyContinuationEnabled: =0), a saved geometry context entropy model (_ctxtMemGeom) and attribute context entropy model (_ctxtMemAttrs) are initialized. Then the current frame is encoded/decoded, and a context entropy model of the current encoded slice/frame is saved. If the current frame is a P-frame with inter continuation enabled (GoFGeometryEntropyContinuationEnabled: =1), when coding the first slice (firstSliceInFrame: =1) of the current frame, a geometry context entropy model (_ctxtMemGeom) saved in an immediately previous frame (_refFrame) is used, while an attribute entropy model (_ctxtMemAttrs) is still initialized. Then the current slice/frame is encoded/decoded, and a geometry context entropy model (_ctxtMemGeom) of the current encoded slice/frame is saved.

If entropy continuation between slices is enabled (firstSliceInFrame: =0, which means the current slice is not the first slice of the current frame), there is no need to consider inter entropy continuation. The geometry context entropy model (_ctxtMemGeom) saved in the immediately previous slice is directly used to encode/decode the current slice/frame. Then the geometry context entropy model (_ctxtMemGeom) of the current encoded slice/frame is saved.

In simple terms, in the above-mentioned related technologies, high-level syntax completeness of entropy continuation between slices/frames is insufficient, and an inheritance of the entropy continuation enable flags at a sequence parameter level and a geometry/attribute parameter level is unclear. For example, the gps.interPredictionEnabledFlag at a GPS-layer is not controlled by the sps.inter_frame_prediction_enabled_flag at a SPS-layer, which increases the complexity of decoding. Meanwhile, in the above-mentioned related technologies, when inter entropy continuation is enabled, only an entropy model saved in the last slice of a prediction frame is used for the first slice of the current frame. When encoding/decoding other slices of the current frame, only an entropy model of the immediately previous slice to the current encoded/decoded slice can be used, and an entropy model in a reference frame cannot be flexibly used.

To solve the above problems, embodiments of the disclosure provide a point cloud coding method. At an encoding end, first flag information corresponding to a current processing unit is determined and the first flag information is signalled into a bitstream, where the first flag information is flag information corresponding to a sequence parameter set of a point cloud. According to the first flag information, second flag information corresponding to the current processing unit is determined and the second flag information is signalled into the bitstream, where the second flag information is flag information corresponding to a geometry parameter set. A probability model corresponding to the current processing unit is determined based on the second flag information, and a prediction value of the current processing unit is obtained according to the probability model. At a decoding end, the bitstream is decoded to determine the first flag information corresponding to the current processing unit, where the first flag information is the flag information corresponding to the sequence parameter set of the point cloud. According to the first flag information, the second flag information is determined corresponding to the current processing unit. The second flag information is the flag information corresponding to the geometry parameter set. The probability model is determined based on the second flag information, and the prediction value of the current processing unit is obtained according to the probability model. In this way, in a process of encoding and decoding the current processing unit, the second flag information corresponding to the current processing unit can be controlled by determining the first flag information corresponding to the current processing unit, and inheritance of entropy continuation enabled flags can be clarified. Therefore, encoding and decoding operations can be simplified and encoding and decoding performance of the point cloud can be improved.

Embodiments of the disclosure will be described in detail below with reference to the accompanying drawings.

An embodiment of the disclosure provides a point cloud decoding method. FIG. 12 illustrates a schematic diagram of an implementation process of the point cloud decoding method provided in an embodiment of the disclosure. As illustrated in FIG. 12, the decoding process of the point cloud may include the following steps.

Step 101, a bitstream is decoded to determine first flag information corresponding to a current processing unit, where the first flag information is flag information corresponding to a sequence parameter set of a point cloud (hereinafter sequence parameter set).

In an embodiment of the disclosure, the bitstream may be decoded first to determine the first flag information corresponding to the current processing unit, where the first flag information is the flag information corresponding to the sequence parameter set.

It should be noted that the decoding method described in embodiments of the disclosure specifically refers to a point cloud decoding method, which may be applied to a point cloud decoder (also referred to as “decoder” for short).

It should be noted that in embodiments of the disclosure, a to-be-processed point cloud may contain at least one to-be-processed unit. During decoding of any one unit among the to-be-processed units, the unit may serve as the current processing unit in the to-be-processed point cloud. The current processing unit is a to-be-decoded unit that needs to be decoded currently among the at least one unit.

Furthermore, in embodiments of the disclosure, each to-be-processed unit in the to-be-processed point cloud corresponds to geometry information and attribute information, where the geometry information represents a spatial relationship of the unit, and the attribute information represents information related to attributes of the unit.

The attribute information may be color information, reflectance, or other attributes, which is not specifically limited in embodiments of the disclosure. When the attribute information is color information, the attribute information may specifically be color information in any color space. Exemplarily, the attribute information may be color information in RGB space, color information in YUV space, or color information in YCbCr space, etc., which is also not specifically limited in embodiments of the disclosure.

Exemplarily, in embodiments of the disclosure, the current processing unit may be a slice to be currently encoded/decoded.

In addition, in embodiments of the disclosure, tiles and slices in G-PCC may be partitioned. FIG. 13 illustrates a schematic diagram of tile and slice partitioning provided in an embodiment of the disclosure. As illustrated in FIG. 13, for slice partitioning, after inputting the point cloud, the original point cloud is first quantized according to corresponding criteria. Then a quantized point cloud is partitioned into several tiles, where a tile is a cube region with a side length of TileSize, and tile bounding box information is contained in a tileinventory syntax. When a number of points in one tile is greater than the maximum number of points (MaxPointNum) of a slice, each tile is partitioned into slices. After slice partitioning, the origin of each slice is calculated according to the partitioned slices, and the slice origin is set as a bounding box origin of the slice.

Slice partitioning mainly includes two steps. First, preliminary partitioning is performed using a slice partitioning scheme, then slices are refined by merging and splitting operations on the slice based on two parameters, i.e., MaxPointNum and MinPointNum, in order to obtain a slice with an appropriate number of points. As illustrated in FIG. 12, during the tile and slice partitioning, whether to perform the tile partitioning may first be determined. If the determination result is yes, the tile partitioning is performed. Then whether the number of points NumPoint is greater than or equal to sliceMaxPoints is determined, where sliceMaxPoints is an upper-limit of the number of points in each slice, and the point cloud is partitioned until this constraint is satisfied. A tile loop process also includes a slice loop process, which mainly determines whether to perform the slice partitioning. After determining that the slice partitioning is needed, an operation of refining the slices is performed, and finally a compress partition is obtained. In addition, in the slice partitioning operation, there is also a parameter sliceMinPoints, which is the minimum number of points in each slice. This threshold is used for merging small slices.

Furthermore, in embodiments of the disclosure, for the slice partitioning scheme, uniform-geometry partitioning may be performed along the longest edge or using an octree. If the number of points is greater than MaxPointNum, the slice partitioning is performed. Otherwise, the entire point cloud is compressed directly without partitioning. The TMC13 software supports two slice partitioning schemes in the encoder, one is uniform-geometry partitioning along the longest edge or using an octree, and the other is uniform square partitioning.

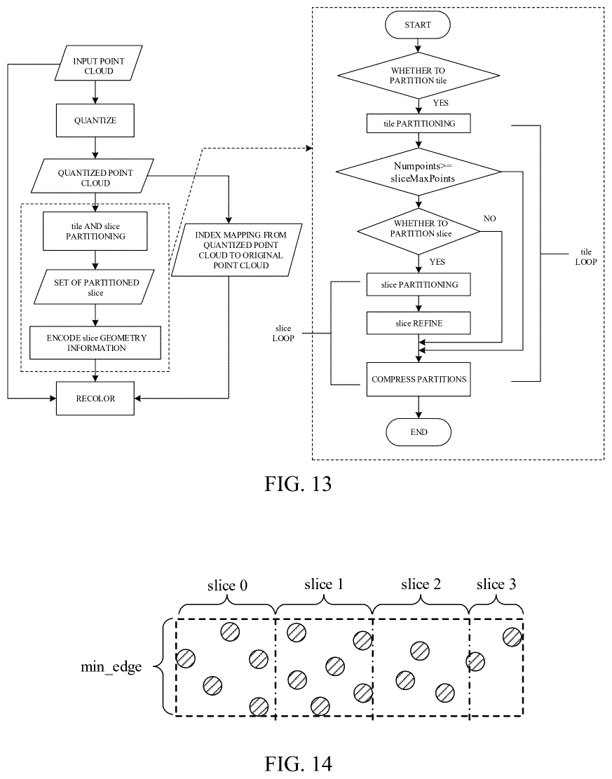

FIG. 14 illustrates a first schematic diagram of a slice partitioning scheme provided in an embodiment of the disclosure. FIG. 14 illustrates the uniform-geometry partition along the longest edge. At first, assume that the longest edge is maxEdge and the shortest edge is minEdge, the number of slices is sliceNum, and a slice size is sliceSize. A default value of sliceNum is maxEdge/minEdge, and a default value of sliceSize is minEdge. Then the slice size may be adjusted to sliceSize. The uniform-geometry partition scheme is used for partitioning the point cloud into a number sliceNum of slices, such as slice0, slice1, slice2, and slice3 illustrated in FIG. 13. The ratio of slices whose point count is less than MaxPointNum to a total number of slices is calculated. A ratio threshold is set, and if the ratio is greater than the ratio threshold, a next step is performed. Otherwise, the process returns to the previous step and sliceNum is doubled.

Furthermore, when using trisoup, whether an original slice partitioning interval is an integer multiple of a block size W=2^{trisoup_node_size_log 2} is first checked. If not, the slice interval is rounded to the nearest integer that is exactly divisible by the block size.

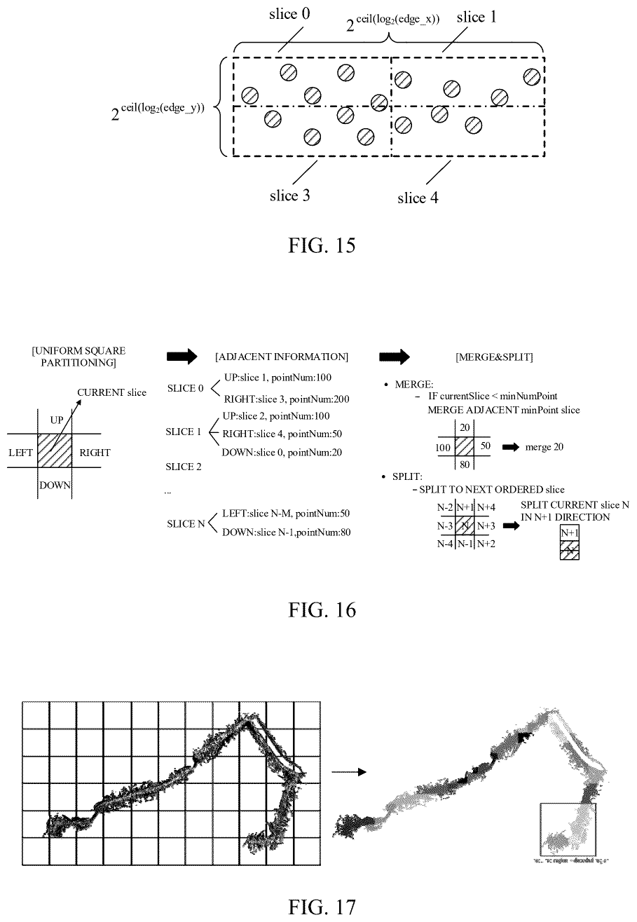

FIG. 15 illustrates a second schematic diagram of a slice partitioning scheme provided in an embodiment of the disclosure. FIG. 15 illustrates the uniform-geometry partition using Octree. At first, the default octree subdivision depth depOctree is set to 1. Then the octree partitioning scheme is used to partition the input point cloud into 8depOctree slices. A ratio of slices whose point count is less than MaxPointNum to a total number of slices is calculated. A ratio threshold is set, and if the ratio is greater than the ratio threshold, a next step is performed. Otherwise, the process returns to the previous step and set depOctree+=1.

In addition, in embodiments of the disclosure, after the slice partitioning, a slice of the point cloud with a point count greater than MaxPointNum is split, and slices of the point cloud with too few points are merged.

Split means that if the point count (Asize) is greater than MaxPointNum, the slice is split into n partitions, where n=ceil (Asize/MaxPointNum). Merge means that if the point count of the current slice is less than MinPointNum, the slice is merged with an immediately previous slice or an immediately next slice. A principle for selecting a merging direction is as follows. If the current slice is at the beginning, the merging direction is to merge with the immediately next slice. If the current slice is at the end, the merging direction is to merge with the immediately previous slice. If the current slice is neither the first nor the last slice, assume that the number of points in a slice obtained by merging the current slice with the immediately previous slice is SumFront, and the number of points in a slice obtained by merging the current slice with the immediately next slice is SumNext. If SumFront>MaxPointNum and SumNext>MaxPointNum, or SumFront<MaxPointNum and SumNext<MaxPointNum, the direction yielding more points after merging is selected. If one of SumFront and SumNext is greater than MaxPointNum and the other is less than MaxPointNum, the merging direction yielding less points is selected. After merging, iterate through all slices generated by merging. Assume the number of points in a merged slice is SumMerged, and SumMerged is compared with MaxPointNum. If SumMerged<MinPointNum, the current merged slice is saved. If SumMerged>MaxPointNum, the merged slice is split using MaxPointNum as the interval. If MinPointNum<SumMerged<MaxPointNum, the current slice is saved and a next slice is checked.

For the uniform square partition scheme, to partition slices in a local region, the scheme first partitions the slices into uniform squares. MaxAxis and midAxis are divided by the length of minAxis. FIG. 16 illustrates a third schematic diagram of a slice partitioning scheme provided in an embodiment of the disclosure. FIG. 16 illustrates a process of uniform square partitioning grid with the following specific procedure. First, adjacent information is generated. Each unrefined slice has adjacent information in a grid region, and four directions (down, left, up, right) of the current slice are the adjacent information. Then merging is performed with a slice with the smallest number of points among four slices. Next, splitting is performed in a direction of a next ordered slice. After merging and splitting, a position of a refined slice is adapted to the region. FIG. 17 illustrates a schematic diagram of slice decoding and a decoding example based on the process of uniform square partitioning grid.

The three slice partitioning schemes described above use different refinement processes. The merging and splitting processes of uniform geometry partition and octree uniform partitioning use the slice in a forward or backward direction, while the merging and splitting processes of uniform square partitioning use the slices in the four directions (up, down, right, left). To integrate the two different refinement schemes, a merging and splitting process using adjacent slice information in six directions (up, down, right, left, front, back) is introduced. For uniform geometry partition, each slice only has left and right slice information corresponding to a 2D domain. For uniform square partition, each slice has up, down, right, and left slice information. For octree uniform partition, each slice has slice information in the six directions. To integrate all schemes, the implementation using slice information in the four directions can be modified to use slice information in the six directions.

Furthermore, in an embodiment of the disclosure, the first flag information is the flag information corresponding to a sequence parameter set (SPS) of the point cloud.

Furthermore, in an embodiment of the disclosure, the following table defines SPS-layer syntax elements and descriptors corresponding to the syntax elements, where a descriptor refers to an entropy decoding algorithm for a syntax element.

TABLE 2

| | Syntax Element | Meaning | Descriptor |
|---|---|---|---|
| SPS | sps.inter_frame_prediction_enabled_flag | SPS-layer inter-frame | u(1) |
| | | prediction enabled flag | |
| | sps.profile.slice_reordering_constraint_flag | Whether slice | u(1) |
| | | bitstream reordering is | |
| | | not allowed at SPS- | |
| | | layer | |
| | sps.entropy_continuation_enabled_flag | SPS-layer entropy | u(1) |
| | | continuation enabled | |
| | | flag | |
| | sps.inter_entropy_continuation_enabled_flag | SPS-layer inter | u(1) |
| | | entropy continuation | |
| | | enabled flag | |
| | sps.intra_entropy_continuation_enabled_flag | SPS-layer intra | u(1) |
| | | entropy continuation | |
| | | enabled flag | |

Among the above descriptors, u(n) indicates reading consecutive n bit(s), and a decoded value of the n bit(s) is an unsigned integer.

It should be noted that in an embodiment of the disclosure, decoding processes in three scenarios are supported. In the first scenario, storage of a probability model of any slice in a reference frame and a current frame is allowed for inheritance by a current decoding slice, sps.profile.slice_reordering_constraint_flag is obtained through parameter configuration or an encoding-end decision algorithm and is signalled into a bitstream. In the second scenario, storage of a probability model of any slice is not allowed, and only a probability model of an immediately previous slice can be inherited, and bitstream reordering of slices is not allowed, that is, an order of slices remains consistent during decoding. In the third scenario, storage of the probability model of any slice in the reference frame and the current frame is allowed for inheritance by each slice, and slice reordering is allowed, that is, sps.profile.slice_reordering_constraint_flag is false. Orders of slices during encoding and decoding may not be completely consistent. In the third scenario, only inter entropy continuation is allowed, while intra entropy continuation is not allowed.

It should be noted that in an embodiment of the disclosure, “inheritance” refers to using a probability model corresponding to a reference unit when determining a probability model corresponding to the current processing unit. More specifically, “inheritance” may involve using a probability value in the probability model corresponding to the reference unit as an initial probability value of the probability model corresponding to the current processing unit. The following describe a decoding process in the first scenario.

Furthermore, in an embodiment of the disclosure, the first flag information is flag information corresponding to the SPS layer, and may contain a first entropy continuation enabled flag, a first inter-frame prediction enabled flag, a first intra entropy continuation enabled flag, and a first inter entropy continuation enabled flag.

Furthermore, in an embodiment of the disclosure, the first inter-frame prediction enabled flag is used for determining whether dependency between different frames is allowed in the sequence parameter set. The first entropy continuation enabled flag is used for determining whether a reference entropy coding probability model is allowed to be used in the sequence parameter set. The first intra entropy continuation enabled flag is used for determining whether an intra reference entropy coding probability model is allowed to be used in the sequence parameter set. The first inter entropy continuation enabled flag is used for determining whether a reference entropy coding probability model of a different frame is allowed to be used in the sequence parameter set.

Furthermore, in an embodiment of the disclosure, the first entropy continuation enabled flag is a SPS-layer entropy continuation enabled flag sps.entropy_continuation_enabled_flag. The first inter-frame prediction enabled flag is a SPS-layer inter-frame prediction enabled flag sps.inter_frame_prediction_enabled_flag. The first intra entropy continuation enabled flag is a SPS-layer sps.intra_entropy_continuation_enabled_flag. The first inter entropy continuation enabled flag is a SPS-layer inter entropy continuation enabled flag sps.inter_entropy_continuation_enabled_flag.

Furthermore, in an embodiment of the disclosure, for the decoding process in the first scenario, flag information at the SPS-layer may be first read and decoded. Then flag information at a geometry parameter set (GPS) layer is decoded, and subsequently flag information at a geometry brick header (GBH) layer is decoded, so as to determine an entropy decoding probability model corresponding to the current processing unit. The flag information at the GPS layer may be controlled by the flag information at the SPS layer, and the flag information at the GBH layer may be controlled by the flag information at the GPS layer. In this case, the inheritance of entropy continuation enabled flags can be clarified, entropy continuation logic between slices and frames can be more accurate, and decoding operations can be simplified.

The geometry brick header information refers to geometry header information of a slice.

Furthermore, in an embodiment of the disclosure, when determining the first flag information corresponding to the current processing unit, the bitstream may be decoded to determine the first entropy continuation enabled flag and the first inter-frame prediction enabled flag. If a value of the first entropy continuation enabled flag is a first value, the bitstream is decoded to determine the first intra entropy continuation enabled flag. If the value of the first entropy continuation enabled flag is the first value and a value of the first inter-frame prediction enabled flag is a second value, the bitstream is decoded to determine the first inter entropy continuation enabled flag.

Furthermore, in an embodiment of the disclosure, the first entropy continuation enabled flag may be the first value or a third value. For example, the first value may be true, and the third value may be false.

For example, in an embodiment of the disclosure, when decoding the flag information at the SPS-layer, sps.inter_frame_prediction_enabled_flag (the first inter-frame prediction enabled flag) and sps.entropy_continuation_enabled_flag (the first entropy continuation enabled flag) may be decoded first. If sps.entropy_continuation_enabled_flag is true (the first value), sps.intra_entropy_continuation_enabled_flag (the first intra entropy continuation enabled flag) is decoded. If sps.inter_frame_prediction_enabled_flag (the first inter-frame prediction enabled flag) is true and sps.entropy_continuation_enabled_flag (the first entropy continuation enabled flag) is true, sps.inter_entropy_continuation_enabled_flag (the first inter entropy continuation enabled flag) is decoded.

Furthermore, in an embodiment of the disclosure, the first flag information further contains a first reordering flag, and the bitstream may be decoded to determine the first reordering flag.

It should be noted that in an embodiment of the disclosure, the first reordering flag is sps.profile.slice_reordering_constraint_flag.

Exemplarily, in an embodiment of the disclosure, the process of decoding the flag information at the SPS-layer described above may be expressed as follows:

```
parseSPS( ){
  sps.inter_frame_prediction_enabled_flag
  sps.entropy_continuation_enabled_flag
  if(sps.entropy_continuation_enabled_flag){
    sps.intra_entropy_continuation_enabled_flag
    if(sps.inter_frame_prediction_enabled_flag)
      sps.inter_entropy_continuation_enabled_flag
  }
sps.profile.slice_reordering_constraint_flag
}
```

Furthermore, in an embodiment of the disclosure, the first flag information may not contain the first entropy continuation enabled flag, that is, the bitstream may not contain the first entropy continuation enabled flag and only contain the first intra entropy continuation enabled flag and the first inter entropy continuation enabled flag. Thus, when decoding the first flag information, the bitstream may be decoded to determine the first inter-frame prediction enabled flag and the first intra entropy continuation enabled flag. If the value of the first inter-frame prediction enabled flag is the second value, the first inter entropy continuation enabled flag is decoded.

Furthermore, in an embodiment of the disclosure, after decoding the first intra entropy continuation enabled flag, the first inter entropy continuation enabled flag, and the first inter-frame prediction enabled flag described above, the first reordering flag may also be decoded.

Exemplarily, in an embodiment of the disclosure, the above decoding process that does not involve the first entropy continuation enabled flag may be expressed as follows:

```
parseSPS( ){
  sps.inter_frame_prediction_enabled_flag
  sps.intra_entropy_continuation_enabled_flag
  if(sps.inter_frame_prediction_enabled_flag)
    sps.inter_entropy_continuation_enabled_flag
  }
  sps.profile.slice_reordering_constraint_flag
}
```

It should be noted that in an embodiment of the disclosure, the first reordering flag is used for determining whether bitstream reordering is constrained.

It should be noted that in an embodiment of the disclosure, when the first reordering flag sps.profile.slice_reordering_constraint_flag is 1, it indicates that the decoded bitstream is sensitive to an order of slice bitstreams, and an order of slices should not be changed before decoding (e.g., during transmission). When the first reordering flag is 0, it indicates that the decoded bitstream is not sensitive to the order of the slice bitstreams, and changing the order of slices before decoding (e.g., during transmission) is allowed.

Furthermore, in an embodiment of the disclosure, the first reordering flag and entropy continuation are mutually exclusive.

Furthermore, in an embodiment of the disclosure, after determining the first reordering flag, verification processing may be performed according to the first reordering flag and the first entropy continuation enabled flag. Specifically, an assertion check may be performed according to the first reordering flag and the first entropy continuation enabled flag.

Furthermore, in some embodiments of the disclosure, after parsing out the first reordering flag sps.profile.slice_reordering_constraint_flag, whether there is a conflict between syntax elements needs to be further verified. For example, when sps.profile.slice_reordering_constraint_flag is true, it means that an ordering of slices in a sequence is constrained, and normal intra inter-slice entropy continuation and inter slice entropy continuation may be performed. However, if sps.profile.slice_reordering_constraint_flag is false, it means that the ordering of slices in the sequence is not constrained. After a compressed bitstream file is transmitted, the order of slices in the bitstream file to be decoded by the decoder may be disrupted. In this case, the first entropy continuation enabled flag sps.entropy_continuation_enabled_flag should not be allowed to be true. Therefore, after parsing the SPS-layer parameters, the verification processing should be performed on the first reordering flag and the first entropy continuation enabled flag.

Exemplarily, in an embodiment of the disclosure, a process of performing the verification processing according to the first reordering flag and the first entropy continuation enabled flag described above may be expressed as follows:

if (sps.entropy_continuation_enabled_flag)
assert(sps.profile.slice_reordering_constraint_flag)

Furthermore, in an embodiment of the disclosure, during the above verification process, if the assert ( ) check fails, decoding is terminated; otherwise, remaining decoding steps are continued.

Furthermore, in an embodiment of the disclosure, since the first reordering flag and entropy continuation are mutually exclusive, the verification processing may also be performed according to the first reordering flag and the first inter entropy continuation enabled flag.

Exemplarily, in an embodiment of the disclosure, a process of performing the verification processing according to the first reordering flag and the first inter entropy continuation enabled flag described above may be expressed as follows:

if (sps.inter_entropy_continuation_enabled_flag)
assert(sps.profile.slice_reordering_constraint_flag)

Furthermore, in an embodiment of the disclosure, since the first reordering flag and entropy continuation are mutually exclusive, decoding of the entropy continuation flag may also be constrained by the first reordering flag during the decoding process. Specifically, the bitstream may be decoded to determine the first inter-frame prediction enabled flag and the first reordering flag. If the value of the first reordering flag is 1, the bitstream is decoded to determine the first entropy continuation enabled flag. If the first entropy continuation enabled flag is the first value (true), the bitstream is decoded to determine the first intra entropy continuation enabled flag. If the value of the first entropy continuation enabled flag is the first value (true) and the value of the first inter-frame prediction enabled flag is the second value (true), the bitstream is decoded to determine the first inter entropy continuation enabled flag.

Exemplarily, in an embodiment of the disclosure, a process of constraining decoding of the entropy continuation flag through the first reordering flag described above may be expressed as follows:

```
  parseSPS( ){
    sps.inter_frame_prediction_enabled_flag
    sps.profile.slice_reordering_constraint_flag
    if(sps.profile.slice_reordering_constraint_flag)
      sps.entropy_continuation_enabled_flag
    if(sps.entropy_continuation_enabled_flag){
      sps.intra_entropy_continuation_enabled_flag
      if(sps.inter_frame_prediction_enabled_flag)
        sps.inter_entropy_continuation_enabled_flag
      }
}
```

Furthermore, in an embodiment of the disclosure, if the value of the first reordering flag is a thirty-fourth value (0), without decoding the bitstream, it may be inferred that any one of the first entropy continuation enabled flag, the first intra entropy continuation enabled flag, or the first inter entropy continuation enabled flag is false.

That is to say, in an embodiment of the disclosure, if the value of the first reordering flag is the thirty-fourth value, the first entropy continuation enabled flag is determined as the third value (false), or the value of the first intra entropy continuation enabled flag is determined as a thirty-fifth value (false), or the value of the first inter-frame prediction enabled flag is determined as a fourth value (false), or the value of the first inter entropy continuation enabled flag is determined as a thirty-sixth value (false).

Furthermore, in an embodiment of the disclosure, if the value of the first entropy continuation enabled flag is the third value (false), a determination process of the first intra entropy continuation enabled flag is not performed.

Furthermore, in an embodiment of the disclosure, if the value of the first entropy continuation enabled flag is the third value, or the value of the first inter-frame prediction enabled flag is the fourth value (false), a determination process of the first inter entropy continuation enabled flag is not performed.

Step 102, second flag information corresponding to the current processing unit is determined according to the first flag information. The second flag information is flag information corresponding to a geometry parameter set.

In an embodiment of the disclosure, after decoding the bitstream to determine the first flag information corresponding to the current processing unit, the second flag information corresponding to the current processing unit may be determined according to the first flag information. The second flag information is the flag information corresponding to the geometry parameter set.

Furthermore, in an embodiment of the disclosure, the second flag information is the flag information at the geometry parameter set (GPS) layer, and the second flag information may contain a second inter-frame prediction enabled flag, a second entropy continuation enabled flag, and a second inter entropy continuation enabled flag.

Furthermore, in an embodiment of the disclosure, the second inter-frame prediction enabled flag is a GPS-layer inter-frame prediction enabled flag gps.inter_frame_prediction_enabled_flag. The second entropy continuation enabled flag is a GPS-layer entropy continuation enabled flag gps.entropy_continuation_enabled_flag. The second inter entropy continuation enabled flag is a GPS-layer inter entropy continuation enabled flag gps.inter_entropy_continuation_enabled_flag.

Furthermore, in an embodiment of the disclosure, the second inter-frame prediction enabled flag is used for determining whether dependency between different frames is allowed in the geometry parameter set. The second entropy continuation enabled flag is used for determining whether a reference entropy coding probability model is allowed to be used in the geometry parameter set. The second inter entropy continuation enabled flag is used for determining whether a reference entropy coding probability model of a different frame is allowed to be used in the geometry parameter set. The second intra entropy continuation enabled flag is used for determining whether an intra reference entropy coding probability model is allowed to be used in the geometry parameter set.

Furthermore, in an embodiment of the disclosure, the following table defines GPS-layer syntax elements (i.e., the second flag information) and corresponding descriptors of the syntax elements in the disclosure.

TABLE 3

| | Syntax Element | Meaning | Descriptor |
|---|---|---|---|
| GPS | gps.inter_frame_prediction_enabled_flag | GPS-layer inter-frame | u(1) |
| | | prediction enabled flag | |
| | gps.entropy_continuation_enabled_flag | GPS-layer entropy | u(1) |
| | | continuation enabled | |
| | | flag | |
| | gps.inter_entropy_continuation_enabled_flag | GPS-layer inter entropy | u(1) |
| | | continuation enabled | |
| | | flag | |
| | gps.intra_entropy_continuation_enabled_flag | GPS-layer intra entropy | u(1) |
| | | continuation enabled | |
| | | flag | |

Among the above descriptors, u (n) indicates reading consecutive n bit(s).

Furthermore, in some embodiments of the disclosure, when determining the second flag information corresponding to the current processing unit according to the first flag information, the second inter-frame prediction enabled flag may be determined according to the first inter-frame prediction enabled flag, and the second entropy continuation enabled flag may be determined according to the first entropy continuation enabled flag.

Furthermore, in some embodiments of the disclosure, when determining the second inter-frame prediction enabled flag according to the first inter-frame prediction enabled flag, if the value of the first inter-frame prediction enabled flag is a second value, the bitstream is decoded to determine the second inter-frame prediction enabled flag.

Furthermore, in some embodiments of the disclosure, the first inter-frame prediction enabled flag may be the second value or the fourth value. For example, the second value may be true, and the fourth value may be false.

Exemplarily, in an embodiment of the disclosure, if sps.inter_frame_prediction_enabled_flag (the first inter-frame prediction enabled flag) is true (the second value), gps.inter_frame_prediction_enabled_flag (the second inter-frame prediction enabled flag) is decoded.

Furthermore, in some embodiments of the disclosure, if the value of the first inter-frame prediction enabled flag is the fourth value, a determination process of the second inter-frame prediction enabled flag is not performed.

Furthermore, in some embodiments of the disclosure, when determining the second entropy continuation enabled flag according to the first entropy continuation enabled flag, if the value of the first entropy continuation enabled flag is the first value, the bitstream is decoded to determine the second entropy continuation enabled flag.

Exemplarily, in an embodiment of the disclosure, if sps.entropy_continuation_enabled_flag (the first entropy continuation enabled flag) is true, gps.entropy_continuation_enabled_flag (the second entropy continuation enabled flag) is decoded.

Furthermore, in some embodiments of the disclosure, if the value of the first entropy continuation enabled flag is the third value, a determination process of the second entropy continuation enabled flag is not performed.

Furthermore, in some embodiments of the disclosure, if the value of the first inter-frame prediction enabled flag is the fourth value, or the value of the first entropy continuation enabled flag is the third value, a determination process of the second inter entropy continuation enabled flag is not performed.

Furthermore, in some embodiments of the disclosure, the second flag information further contains the second intra entropy continuation enabled flag. If a value of the second entropy continuation enabled flag is a fifth value, the bitstream is decoded to determine the second intra entropy continuation enabled flag.

Furthermore, in some embodiments of the disclosure, the second entropy continuation enabled flag may be the fifth value or a sixth value. For example, the fifth value may be true, and the sixth value may be false.

Exemplarily, in an embodiment of the disclosure, if gps.entropy_continuation_enabled_flag (the second entropy continuation enabled flag) is true (the fifth value), gps.intra_entropy_continuation_enabled_flag (the second intra entropy continuation enabled flag) is decoded.

Furthermore, in some embodiments of the disclosure, if the value of the second entropy continuation enabled flag is the sixth value (false), a determination process of the second intra entropy continuation enabled flag is not performed.

Furthermore, in some embodiments of the disclosure, the second flag information further contains the second inter entropy continuation enabled flag. If the value of the second entropy continuation enabled flag is the fifth value and a value of the second inter-frame prediction enabled flag is a seventh value, the bitstream is decoded to determine the second inter entropy continuation enabled flag.

Furthermore, in some embodiments of the disclosure, the value of the second inter-frame prediction enabled flag may be the seventh value or an eighth value. For example, the seventh value may be true, and the eighth value may be false.

Exemplarily, in an embodiment of the disclosure, if gps.entropy_continuation_enabled_flag (the second entropy continuation enabled flag) is true (the fifth value), and gps.inter_frame_prediction_enabled_flag (the second inter-frame prediction enabled flag) is true (the seventh value), gps.inter_entropy_continuation_enabled_flag (the second inter entropy continuation enabled flag) is decoded.

Exemplarily, in an embodiment of the disclosure, a process of decoding the GPS-layer flag information described above may be expressed as follows:

```
parseGPS( ){
  if(sps.inter_frame_prediction_enabled_flag)
    gps.inter_frame_prediction_enabled_flag
  if(sps.entropy_continuation_enabled_flag){
    gps.entropy_continuation_enabled_flag
    if(gps.entropy_continuation_enabled_flag){
      gps.intra_entropy_continuation_enabled_flag
      if(gps.inter_frame_prediction_enabled_flag)
        gps.inter_entropy_continuation_enabled_flag
    }
  }
}
```

Furthermore, in some embodiments of the disclosure, if the value of the second entropy continuation enabled flag is the sixth value, or the value of the second inter-frame prediction enabled flag is the eighth value, the determination process of the second inter entropy continuation enabled flag is not performed.

Furthermore, in an embodiment of the disclosure, since the first reordering flag and entropy continuation are exclusive, the verification processing may be performed according to the first reordering flag and the second entropy continuation enabled flag. Specifically, an assertion check may be performed according to the first reordering flag and the second entropy continuation enabled flag.

Exemplarily, in an embodiment of the disclosure, a process of performing the verification processing according to the first reordering flag and the second entropy continuation enabled flag described above may be expressed as follows:

if (gps.entropy_continuation_enabled_flag)
assert(sps.profile.slice_reordering_constraint_flag)

Step 103, a probability model is determined based on the second flag information, and a prediction value of the current processing unit is obtained according to the probability model.

In an embodiment of the disclosure, after determining the second flag information corresponding to the current processing unit according to the first flag information, the probability model may be determined based on the second flag information, and the prediction value of the current processing unit may be obtained according to the probability model.

It should be noted that in an embodiment of the disclosure, the probability model may be an entropy coding probability model, which is also referred to as a context model.

Furthermore, in some embodiments of the disclosure, when determining the probability model based on the second flag information, third flag information corresponding to the current processing unit may be determined according to the second flag information. The third flag information is flag information corresponding to geometry brick header (GBH) information. Then the probability model corresponding to the current processing unit is determined according to the third flag information.

Furthermore, in an embodiment of the disclosure, the third flag information is flag information at a GBH-layer, and the third flag information may contain at least a third inter-frame prediction enabled flag, a third entropy continuation enabled flag, and a third inter entropy continuation mode flag.

Furthermore, in an embodiment of the disclosure, the third inter-frame prediction enabled flag is a GBH-layer inter-frame prediction enabled flag gbh.inter_frame_prediction_enabled_flag. The third entropy continuation enabled flag is a GBH-layer entropy continuation enabled flag gbh.entropy_continuation_enabled_flag. The third inter entropy continuation mode flag is a GBH-layer inter entropy continuation mode flag gbh.entropy_continuation_mode.

Furthermore, in an embodiment of the disclosure, the third inter-frame prediction enabled flag is used for determining whether dependency between different frames is allowed in the geometry brick header information. The third entropy continuation enabled flag is used for determining whether a reference entropy coding probability model is allowed to be used in the geometry brick header information. The third inter-frame prediction enabled flag is used for determining whether a reference entropy coding probability model of a different frame is allowed to be used in the geometry brick header information. The third inter entropy continuation mode flag is used for determining a source of the entropy coding probability model of the current processing unit.

Furthermore, in an embodiment of the disclosure, the following table defines the third flag information in the disclosure, that is, GBH-layer syntax elements of a slice and corresponding descriptors of the syntax elements.

TABLE 4

| | Syntax Element | Meaning | Descriptor |
|---|---|---|---|
| GBH | gbh.inter_frame_prediction_enabled_flag | GBH-layer inter-frame | u(1) |
| | | prediction enabled flag | |
| | gbh.entropy_continuation_enabled_flag | GBH-layer entropy | u(1) |
| | | continuation enabled flag | |
| | gbh.entropy_continuation_mode | GBH-layer inter entropy | u(2) |
| | | continuation mode (0: | |
| | | Discontinuous; 1: Slice- | |
| | | continuous; 2: Inter | |
| | | continuous) | |
| | gbh. entropy_continuation_slice_id | GBH-layer entropy | ue(v) |
| | | continuation reference slice | |
| | | index | |
| | cur_slice_id | Index value of a current | ue(v) |
| | | slice in the current frame | |

Among the above descriptors, u(n) indicates reading consecutive n bit(s), and a decoded value of the n bit(s) is an unsigned integer. Ue(v) indicates an unsigned exponential-Golomb entropy coding syntax element.

It should be noted that in an embodiment of the disclosure, among all the above flags, a default value of the binary flag parameter encoded with 1 bit is 0 (false). For a mode selection parameter coded with 2 bits, a default value of gbh.entropy_continuation_mode is 0, and a default value of gbh.entropy_continuation_slice_id is −1.

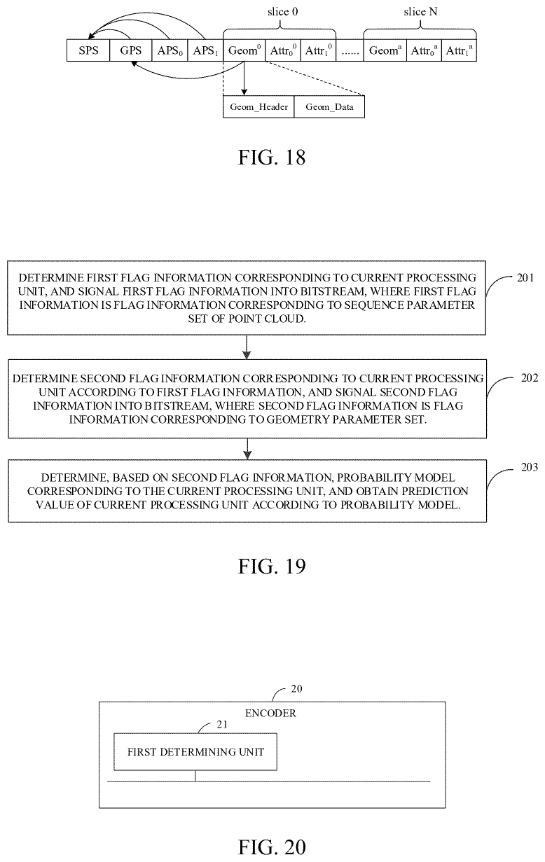

Exemplarily, in an embodiment of the disclosure, FIG. 18 illustrates a schematic diagram of a bitstream structure. FIG. 18 illustrates the bitstream structure of SPS, GPS, and GBH. The GPS-layer may inherit from the SPS-layer, and the GPS-layer is followed by an attribute parameter set (APS) layer. Each slice may contain geometry (Geom) information and attribute (Attr) information, and the Geom information may contain two parts: Geom_Header and Geom Data.

Furthermore, in some embodiments of the disclosure, when determining the third flag information corresponding to the current processing unit according to the second flag information, if the value of the second inter-frame prediction enabled flag is the seventh value, the bitstream is decoded to determine the third inter-frame prediction enabled flag.

Exemplarily, in an embodiment of the disclosure, if gps.inter_frame_prediction_enabled_flag (the second inter-frame prediction enabled flag) is true (the seventh value), gbh.inter_frame_prediction_enabled_flag (the third inter-frame prediction enabled flag) is decoded.

Furthermore, in some embodiments of the disclosure, if the value of the second inter-frame prediction enabled flag is the eighth value (false), a determination process of the third inter-frame prediction enabled flag is not performed.

Furthermore, in some embodiments of the disclosure, if a value of the second inter entropy continuation enabled flag is a ninth value (false), the determination process of the third inter-frame prediction enabled flag is not performed.

Furthermore, in some embodiments of the disclosure, the second inter entropy continuation enabled flag may be the ninth value or a fifteenth value. For example, the ninth value may be false, and the fifteenth value may be true.

Furthermore, in some embodiments of the disclosure, when determining the third flag information corresponding to the current processing unit according to the second flag information, if the value of the second entropy continuation enabled flag is the fifth value, the bitstream is decoded to determine the third entropy continuation enabled flag and the third inter entropy continuation mode flag.

Exemplarily, in an embodiment of the disclosure, if gps.entropy_continuation_enabled_flag (the second entropy continuation enabled flag) is true (the fifth value), gbh.entropy_continuation_enabled_flag (the third entropy continuation enabled flag) and gbh.entropy_continuation_mode (the third inter entropy continuation mode flag) are decoded.

Furthermore, in some embodiments of the disclosure, if the value of the second entropy continuation enabled flag is the sixth value, a determination processes of the third entropy continuation enabled flag and a determination processes of the third inter entropy continuation mode flag are not performed.

Furthermore, in an embodiment of the disclosure, when determining the probability model corresponding to the current processing unit according to the third flag information, the probability model corresponding to the current processing unit may be determined according to the third inter entropy continuation mode flag.

Furthermore, in some embodiments of the disclosure, if a value of the third entropy continuation enabled flag is a tenth value (true), the bitstream is decoded to determine an index value of the current processing unit, and the probability model corresponding to the current processing unit is determined according to the index value of the current processing unit.

Furthermore, in some embodiments of the disclosure, the third entropy continuation enabled flag may be the tenth value or an eleventh value. For example, the tenth value is true, and the eleventh value is false.

Furthermore, in some embodiments of the disclosure, if the value of the third entropy continuation enabled flag is the eleventh value (false), the determination process of the third inter entropy continuation mode flag is not performed.

Furthermore, in some embodiments of the disclosure, when determining the probability model corresponding to the current processing unit according to the index value of the current processing unit, the third inter entropy continuation mode flag may be determined based on the index value of the current processing unit, and the probability model corresponding to the current processing unit is determined according to the third inter entropy continuation mode flag.

Furthermore, in some embodiments of the disclosure, when determining the probability model corresponding to the current processing unit according to the third inter entropy continuation mode flag, if a value of the third inter entropy continuation mode flag is a fourteenth value, the probability model corresponding to the current processing unit is initialized. If the value of the third inter entropy continuation mode flag is a seventeenth value, the probability model corresponding to the current processing unit is determined according to a probability model corresponding to a first reference unit, where the first reference unit and the current processing unit belong to the same frame. If the value of the third inter entropy continuation mode flag is an eighteenth value, the probability model corresponding to the current processing unit is determined according to a probability model corresponding to a second reference unit. The second reference unit is in a frame immediately previous to a frame containing the current processing unit.

Exemplarily, in an embodiment of the disclosure, if gps.entropy_continuation_enabled_flag (the second entropy continuation enabled flag) is true, gbh.entropy_continuation_enabled_flag (the third entropy continuation enabled flag) and gbh.entropy_continuation_mode (the third inter entropy continuation mode flag) are decoded. When gbh.entropy_continuation_mode is 0 (the fourteenth value), it indicates that the current slice does not inherit an entropy model from other slices, and a probability model required for an entropy coding process is initialized. When gbh.entropy_continuation_mode is 1 (the seventeenth value), it indicates that the current slice needs to inherit an entropy model from a certain slice in the same frame. In this case, an index value gbh.entropy_continuation_slice_id of a reference slice in the same frame needs to be decoded, and a probability model of the reference slice is obtained according to gbh.entropy_continuation_slice_id for use in the entropy decoding process of the current slice. When gbh.entropy_continuation_mode is 2 (the eighteenth value), it indicates that the current slice needs to inherit an entropy model from a certain slice in an immediately previous frame. In this case, an index value gbh.entropy_continuation_slice_id of a reference slice in the immediately previous frame is decoded, and the probability model of the current slice is obtained according to gbh.entropy_continuation_slice_id for use in the entropy decoding process of the current slice.

Exemplarily, in an embodiment of the disclosure, the process of decoding GBH parameters described above may be expressed as follows:

```
parseGBH( ){
  if(gps.inter_frame_prediction_enabled_flag)
    gbh.inter_frame_prediction_enabled_flag
  if(gps.entropy_continuation_enabled_flag){
    gbh.entropy_continuation_mode
    if(gbh.entropy_continuation_mode == 1){
      gbh. entropy_continuation_slice_id
    else if(gbh.entropy_continuation_mode!=0)
      gbh. entropy_continuation_slice_id
    }
  }
}
```

Furthermore, in an embodiment of the disclosure, for the first scenario, after all flag information is decoded, verification needs to be performed on results of gbh.inter_frame_prediction_enabled_flag (the third inter-frame prediction enabled flag) and gbh.entropy_continuation_mode (the third inter entropy continuation mode flag). It is necessary to determine that two cases where gbh.inter_frame_prediction_enabled_flag is false and gbh.entropy_continuation_mode is 2 do not occur simultaneously.

Exemplarily, in an embodiment of the disclosure, the verification performed on the results of gbh.inter_frame_prediction_enabled_flag (the third inter-frame prediction enabled flag) and gbh.entropy_continuation_mode (the third inter entropy continuation mode flag) may be represented as follows:
Assert (!((!gbh.inter_frame_prediction_enabled_flag)&&(gbh.entropy_continuation_mode==2)))

It should be noted that in an embodiment of the disclosure, for any one of the three scenarios, after the third inter entropy continuation mode flag is obtained through decoding, the probability model can be determined according to the value of the third inter entropy continuation mode flag.

Exemplarily, in an embodiment of the disclosure, for the first scenario, if gbh.entropy_continuation_mode is 0, an initialization process is performed on the probability model of the current slice. If gbh.entropy_continuation_mode is 1, an index value gbh.entropy_continuation_slice_id of a reference slice in the current frame is decoded, and a probability model of the reference slice is used as the probability model of the current slice (or a final value of the probability model of the reference slice is used as an initial value of the probability model of the current slice). If gbh.entropy_continuation_mode is 2, an index value gbh.entropy_continuation_slice_id of a reference slice in an immediately previous frame is decoded, and a probability model of the reference slice is used as the probability model of the current slice (or a final value of the probability model of the reference slice is used as an initial value of the probability model of the current slice).

The following describe a decoding process in the second scenario.

It should be noted that in an embodiment of the disclosure, for the decoding process in the second scenario, similarly, the SPS-layer flag information is read and decoded first, then the GPS-layer flag information is decoded, and subsequently the GBH-layer flag information is decoded, so as to determine the entropy decoding probability model corresponding to the current processing unit. The GPS-layer flag information may be controlled by the SPS-layer flag information, and the GBH-layer flag information may be controlled by the GPS-layer flag information. In this case, the inheritance among entropy continuation enable flags can be clarified, entropy continuation logic between slices and frames can be more accurate, and decoding operations can be simplified.

It should be noted that in an embodiment of the disclosure, the decoding process in the second scenario is basically similar to the decoding process in the first scenario, but has a difference in decoding the flag information corresponding to the GBH layer.

Furthermore, in an embodiment of the disclosure, for the second scenario, when determining the probability model corresponding to the current processing unit according to the third flag information, if the value of the third entropy continuation enabled flag is the tenth value, the bitstream is decoded to determine the index value of the current processing unit. The probability model corresponding to the current processing unit is determined according to the index value of the current processing unit.

Exemplarily, in an embodiment of the disclosure, in the second scenario, when decoding the GBH-layer flag information, if gps.inter_frame_prediction_enabled_flag (the second inter-frame prediction enabled flag) is true, gbh.inter_frame_prediction_enabled_flag (the third inter-frame prediction enabled flag) is decoded. If gps.entropy_continuation_enabled_flag (the second entropy continuation enabled flag) is true, gbh.entropy_continuation_enabled_flag (the third entropy continuation enabled flag) is decoded. Furthermore, when the value of gbh.entropy_continuation_enabled_flag is true (the tenth value), a judgment may be made according to the index value of the current slice (cur_slice_id) to determine the probability model.

Furthermore, in some embodiments of the disclosure, if the value of the third entropy continuation enabled flag is the eleventh value, the determination process of the third inter entropy continuation mode flag is not performed.

Furthermore, in some embodiments of the disclosure, when determining the probability model corresponding to the current processing unit according to the index value of the current processing unit, the third inter entropy continuation mode flag may be determined based on the index value of the current processing unit. The probability model corresponding to the current processing unit is determined according to the third inter entropy continuation mode flag.

Furthermore, in some embodiments of the disclosure, when determining the third inter entropy continuation mode flag based on the index value of the current processing unit, if the index value of the current processing unit is a twelfth value and the value of the third inter-frame prediction enabled flag is a thirteenth value, the bitstream is decoded to determine the third inter entropy continuation mode flag.

Furthermore, in some embodiments of the disclosure, the third inter-frame prediction enabled flag may be the thirteenth value or a sixteenth value. For example, the thirteenth value is true, and the sixteenth value is false.

Furthermore, in some embodiments of the disclosure, the index value of the current processing unit may be a twelfth value. For example, the twelfth value may be 0.

Furthermore, in some embodiments of the disclosure, if the index value of the current processing unit is not the twelfth value, the bitstream is decoded to determine the third inter entropy continuation mode flag.

Furthermore, in some embodiments of the disclosure, if the index value of the current processing unit is the twelfth value and the third inter-frame prediction enabled flag is not the thirteenth value, the determination process of the third inter entropy continuation mode flag is not performed. The value of the third inter entropy continuation mode flag is determined as the fourteenth value.

Furthermore, in some embodiments of the disclosure, the third inter entropy continuation mode flag may be any one of the fourteenth value, the seventeenth value, and the eighteenth value. For example, the fourteenth value is 0, the seventeenth value is 1, and the eighteenth value is 2.

Exemplarily, in an embodiment of the disclosure, when the value of cur_slice_id (the index value of the current slice) is not 0 (the twelfth value), gbh.entropy_continuation_mode (the third inter entropy continuation mode flag) is decoded. When the value of cur_slice_id is 0 (the twelfth value) and gbh.inter_frame_prediction_enabled_flag (the third inter-frame prediction enabled flag) is true (the thirteenth value), gbh.entropy_continuation_mode (the third inter entropy continuation mode flag) is decoded. Otherwise, gbh.entropy_continuation_mode is not decoded and is set to 0.

Exemplarily, in an embodiment of the disclosure, if the value of cur_slice_id is 0 and gbh.inter_frame_prediction_enabled_flag is false, gbh.entropy_continuation_mode (the third inter entropy continuation mode flag) is not decoded and is set to 0 (the fourteenth value).

Exemplarily, in an embodiment of the disclosure, in the second scenario described above, the manner for decoding the GBH-layer flag information may be expressed as follows:

```
parseGBH( ){
  if(gps.inter_frame_prediction_enabled_flag)
    gbh.inter_frame_prediction_enabled_flag
  if(gps.entropy_continuation_enabled_flag){
    gbh.entropy_continuation_enabled_flag
    if(gbh.entropy_continuation_enabled_flag){
      if(cur_slice_id==0)
        if(gps.inter_frame_prediction_enabled_flag)
          gbh.entropy_continuation_mode
      else
        gbh.entropy_continuation_mode
    }
}
```

Furthermore, in an embodiment of the disclosure, for the second scenario, when determining the probability model corresponding to the current processing unit according to the third inter entropy continuation mode flag, if the value of the third inter entropy continuation mode flag is the fourteenth value, the probability model corresponding to the current processing unit is initialized. If the value of the third inter entropy continuation mode flag is the seventeenth value, the probability model corresponding to the current processing unit is determined according to a probability model corresponding to a third reference unit, where the third reference unit is an immediately previous processing unit of the current processing unit. The third reference unit and the current processing unit belong to the same frame or different frames.

In some embodiments of the disclosure, in the second scenario, after gbh.entropy_continuation_mode is obtained through decoding, a corresponding operation may be performed according to a result of gbh.entropy_continuation_mode. If gbh.entropy_continuation_mode is 0 (the fourteenth value), the slice does not inherit the convergent probability value from the entropy model of another slice, and the probability model required for the entropy coding process is initialized. If gbh.entropy_continuation_mode is 1 (the seventeenth value), the slice needs to inherit a probability model from an immediately previous slice to the current slice in the decoding order. If the current slice is not the first slice of the current frame, the current slice inherits an entropy model of the immediately previous slice in the current frame. If the current slice is the first slice of the current frame, the current slice inherits an entropy model of a last slice in the immediately previous frame.

The following describe a decoding process in the third scenario.

In an embodiment of the disclosure, for a decoding process in the third scenario, only inter entropy continuation is allowed, while intra entropy continuation is not allowed.

Exemplarily, in an embodiment of the disclosure, for the decoding process in the third scenario, similarly, the SPS-layer inter-frame prediction enabled flag sps.inter_frame_prediction_enabled_flag (the first inter-frame prediction enabled flag) and the SPS-layer entropy continuation enabled flag sps.entropy_continuation_enabled_flag (the first entropy continuation enabled flag) may be decoded first, which may be represented by:

```
parseSPS( ){
  sps.inter_frame_prediction_enabled_flag
  sps.entropy_continuation_enabled_flag
}
```

Furthermore, in some embodiments of the present disclosure, the decoding process in the third scenario is similar to the decoding process in the first scenario.

Exemplarily, in an embodiment of the present disclosure, for the decoding process in the third scenario, when determining the third flag information, if sps.inter_frame_prediction_enabled_flag (the first inter-frame prediction enabled flag) is true, gps.inter_frame_prediction_enabled_flag (the second inter-frame prediction enabled flag) is decoded. Otherwise, gps.inter_frame_prediction_enabled_flag (the second inter-frame prediction enabled flag) is defaulted to false.

Furthermore, in some embodiments of the present disclosure, the bitstream can be decoded to determine the first inter-frame prediction enabled flag. If the value of the first inter-frame prediction enabled flag is the fourth value (false), the determination process of the first entropy continuation enabled flag is not performed.

Furthermore, in some embodiments of the present disclosure, when determining the second flag information corresponding to the current processing unit according to the first flag information, if the value of the first entropy continuation enabled flag is the first value and the value of the second inter-frame prediction enabled flag is the seventh value, the bitstream is decoded to determine the second entropy continuation enabled flag.

Exemplarily, in an embodiment of the present disclosure, if sps.entropy_continuation_enabled_flag (the first entropy continuation enabled flag) is true (the first value) and gps.inter_frame_prediction_enabled_flag (the second inter-frame prediction enabled flag) is true, gps.entropy_continuation_enabled_flag (the second entropy continuation enabled flag) is decoded. Otherwise, gps.entropy_continuation_enabled_flag (the second entropy continuation enabled flag) is defaulted to false. The process can be expressed as:

```
parseGPS( ){
  if(sps.inter_frame_prediction_enabled_flag){
    gps.inter_frame_prediction_enabled_flag
    if(sps.entropy_continuation_enabled_flag)
      gps.entropy_continuation_enabled_flag
  }
}
```

Furthermore, in some embodiments of the present disclosure, if the value of the first entropy continuation enabled flag is the third value, or the value of the second inter-frame prediction enabled flag is the eighth value, the determination process of the second entropy continuation enabled flag is not performed.

Furthermore, in some embodiments of the present disclosure, when determining the third flag information corresponding to the current processing unit according to the second flag information, if the value of the second inter entropy continuation enabled flag is the fifteenth value, the bitstream is decoded to determine the third inter-frame prediction enabled flag. If the value of the second inter entropy continuation enabled flag is the ninth value, the determination process of the third inter-frame prediction enabled flag is not performed.

Exemplarily, in an embodiment of the present disclosure, when determining the third flag information, if gps.inter_entropy_continuation_enabled_flag (the second inter entropy continuation enabled flag) is true (the fifteenth value), gbh.inter_frame_prediction_enabled_flag (the third inter-frame prediction enabled flag) is decoded. Otherwise, gbh.inter_frame_prediction_enabled_flag is defaulted to false.

Furthermore, in some embodiments of the present disclosure, when determining the third flag information corresponding to the current processing unit according to the second flag information, if the value of the second entropy continuation enabled flag is the fifth value and the value of the second inter entropy continuation enabled flag is the fifteenth value, the bitstream is decoded to determine the third entropy continuation enabled flag. If the value of the second entropy continuation enabled flag is the sixth value, or the value of the second inter entropy continuation enabled flag is the ninth value, the determination process of the third entropy continuation enabled flag is not performed.

Exemplarily, in an embodiment of the present disclosure, if gps.entropy_continuation_enabled_flag (the second entropy continuation enabled flag) is true (the fifth value) and gps.inter_entropy_continuation_enabled_flag (the second inter entropy continuation enabled flag) is also true (the fifteenth value), gbh.entropy_continuation_enabled_flag (the third entropy continuation enabled flag) is decoded. Otherwise, gbh.entropy_continuation_enabled_flag is defaulted to false.

Furthermore, in some embodiments of the present disclosure, if the value of the third entropy continuation enabled flag is the tenth value and the value of the third inter-frame prediction enabled flag is the thirteenth value, the bitstream is decoded to determine the third inter entropy continuation mode flag. The probability model corresponding to the current processing unit is determined according to the third inter entropy continuation mode flag.

Exemplarily, in an embodiment of the present disclosure, if gbh.entropy_continuation_enabled_flag (the third entropy continuation enabled flag) is true (the tenth value) and gbh.inter_frame_prediction_enabled_flag (the third inter-frame prediction enabled flag) is also true (the thirteenth value), gbh.entropy_continuation_mode (the third inter entropy continuation mode flag) is decoded, so as to determine the probability model of the current slice according to gbh.entropy_continuation_mode. The process of decoding the third flag information described above can be expressed as:

```
    parseGBH( ){
      if(gps.inter_frame_prediction_enabled_flag){
        gbh.inter_frame_prediction_enabled_flag
        if(gps.entropy_continuation_enabled_flag &&
gbh.inter_frame_prediction_enabled_flag){
          gbh.entropy_continuation_enabled_flag
          if(gbh.entropy_continuation_enabled_flag)
            gbh.entropy_continuation_mode
            if(gbh.entropy_continuation_mode==1)
              gbh.entropy_continuation_slice_id
        }
      }
    }
```

Furthermore, in some embodiments of the present disclosure, if the value of the third entropy continuation enabled flag is the eleventh value, or the value of the third inter-frame prediction enabled flag is the sixteenth value, the determination process of the third inter entropy continuation mode flag is not performed.

Furthermore, in an embodiment of the present disclosure, for the third scenario, similarly, a source of an entropy encoding/decoding probability model stored for the current slice can be determined according to the value of gbh.entropy_continuation_mode (the third inter entropy continuation mode flag).

Furthermore, in some embodiments of the present disclosure, for the third scenario, if the value of the third inter entropy continuation mode flag is the fourteenth value, the probability model corresponding to the current processing unit is initialized. If the value of the third inter entropy continuation mode flag is the seventeenth value, the probability model corresponding to the current processing unit is determined according to a probability model corresponding to a fourth reference unit. The fourth reference unit is in a frame immediately previous to the frame containing the current processing unit.

Exemplarily, in an embodiment of the present disclosure, for the third scenario, if the value of gbh.entropy_continuation_mode is 0 (the fourteenth value), the initialization process is performed on the probability model of the current slice. If the value of gbh.entropy_continuation_mode is 1, an index value gbh.entropy_continuation_slice_id of a reference slice in an immediately previous frame is decoded. A probability model of the reference slice is used as the probability model of the current slice (or a final value of the probability model of the reference slice is used as an initial value of the probability model of the current slice).

Furthermore, in an embodiment of the present disclosure, in the decoding processes in the above three scenarios, when initializing the probability model corresponding to the current processing unit, an assignment processing can be performed on a probability value corresponding to the probability model to complete the initialization.

Exemplarily, in an embodiment of the present disclosure, a probability value of 0.5 is assigned to the probability model, thereby completing the initialization of the probability model corresponding to the current processing unit.

Step 104, a fourth flag information corresponding to the current processing unit is determined according to the first flag information. The fourth flag information is flag information corresponding to the attribute parameter set.

In an embodiment of the present disclosure, after determining the second flag information, the fourth flag information corresponding to the current processing unit may further be determined according to the first flag information. The fourth flag information is the flag information corresponding to the attribute parameter set (APS).

It should be noted that in an embodiment of the present disclosure, the first flag information may be decoded first, then the second flag information is decoded, followed by the fourth flag information, then the third flag information, and finally fifth flag information.

In an embodiment of the present disclosure, the fifth flag information is attribute brick header (ABH) information, i.e., attribute header information of a slice.

Furthermore, in an embodiment of the present disclosure, the fourth flag information may contain a fourth inter-frame prediction enabled flag, a fourth entropy continuation enabled flag, a fourth inter entropy continuation enabled flag, and a fourth intra entropy continuation enabled flag.

In an embodiment of the present disclosure, the fourth inter-frame prediction enabled flag is an APS-layer inter-frame prediction enabled flag, the fourth entropy continuation enabled flag is an APS-layer entropy continuation enabled flag, the fourth inter entropy continuation enabled flag is an APS-layer inter entropy continuation enabled flag, and the fourth intra entropy continuation enabled flag is an APS-layer intra entropy continuation enabled flag.

Exemplarily, in an embodiment of the present disclosure, the following table illustrates the syntax elements of the fourth flag information and corresponding descriptors.

TABLE 5

| | Syntax Element | Meaning | Descriptor |
|---|---|---|---|
| APS | aps.inter_frame_prediction_enabled_flag | APS-layer inter-frame | u(1) |
| | | prediction enabled flag | |
| | aps.entropy_continuation_enabled_flag | APS-layer entropy | u(1) |
| | | continuation enabled | |
| | | flag | |
| | aps.inter_entropy_continuation_enabled_flag | APS-layer inter entropy | u(1) |
| | | continuation enabled | |
| | | flag | |
| | aps.intra_entropy_continuation_enabled_flag | APS-layer intra entropy | u(1) |
| | | continuation enabled | |
| | | flag | |

In the above descriptors, u (n) represents reading consecutive n bit(s).

It should be noted that in an embodiment of the present disclosure, the fourth flag information is decoded after the second flag information is determined by decoding the bitstream.

Furthermore, in an embodiment of the present disclosure, when determining the fourth flag information corresponding to the current processing unit according to the first flag information, the fourth inter-frame prediction enabled flag may be determined according to the first inter-frame prediction enabled flag. The fourth entropy continuation enabled flag may be determined according to the first entropy continuation enabled flag.

Furthermore, in some embodiments of the present disclosure, when determining the fourth inter-frame prediction enabled flag according to the first inter-frame prediction enabled flag, if the value of the first inter-frame prediction enabled flag is the second value, the bitstream is decoded to determine the fourth inter-frame prediction enabled flag.

Exemplarily, in an embodiment of the present disclosure, if sps.inter_frame_prediction_enabled_flag (the first inter-frame prediction enabled flag) is true, aps.inter_frame_prediction_enabled_flag (the fourth inter-frame prediction enabled flag) is decoded.

Furthermore, in some embodiments of the present disclosure, if the value of the first inter-frame prediction enabled flag is the fourth value, a determination process of the fourth inter-frame prediction enabled flag is not performed.

Furthermore, in some embodiments of the present disclosure, when determining the fourth entropy continuation enabled flag according to the first entropy continuation enabled flag, if the value of the first entropy continuation enabled flag is the first value, the bitstream is decoded to determine the fourth entropy continuation enabled flag.

Exemplarily, in an embodiment of the present disclosure, if sps.entropy_continuation_enabled_flag (the first entropy continuation enabled flag) is true, aps.entropy_continuation_enabled_flag (the fourth entropy continuation enabled flag) is decoded.

Furthermore, in some embodiments of the present disclosure, if the value of the first entropy continuation enabled flag is the third value, a determination process of the fourth entropy continuation enabled flag is not performed.

Furthermore, in some embodiments of the present disclosure, if the value of the first inter-frame prediction enabled flag is the fourth value, or the value of the first entropy continuation enabled flag is the third value, a determination process of the fourth inter entropy continuation enabled flag is not performed.

Furthermore, in some embodiments of the present disclosure, if a value of the fourth entropy continuation enabled flag is a twentieth value (true), the bitstream is decoded to determine the fourth intra entropy continuation enabled flag.

Exemplarily, in an embodiment of the present disclosure, if the value of aps.entropy_continuation_enabled_flag (the fourth entropy continuation enabled flag) is true, aps.intra_entropy_continuation_enabled_flag (the fourth intra entropy continuation enabled flag) is decoded.

Furthermore, in some embodiments of the present disclosure, if the value of the fourth entropy continuation enabled flag is a twenty-first value (false), a determination process of the fourth intra entropy continuation enabled flag is not performed.

Furthermore, in some embodiments of the present disclosure, if the value of the fourth entropy continuation enabled flag is the twentieth value and the value of the fourth inter-frame prediction enabled flag is a twenty-second value (true), the bitstream is decoded to determine the fourth inter entropy continuation enabled flag.

Furthermore, in some embodiments of the present disclosure, the fourth inter-frame prediction enabled flag may be the twenty-second value or a twenty-third value. For example, the twenty-second value may be true, and the twenty-third value may be false.

Exemplarily, in an embodiment of the present disclosure, if aps.entropy_continuation_enabled_flag (the fourth entropy continuation enabled flag) is true (the twentieth value) and aps.inter_frame_prediction_enabled_flag (the fourth inter-frame prediction enabled flag) is true (the twenty-second value), aps.inter_entropy_continuation_enabled_flag (the fourth inter entropy continuation enabled flag) is decoded.

Exemplarily, in an embodiment of the present disclosure, the decoding process of the APS-layer flag information described above may be expressed as follows:

```
    parseAPS( ){
      if(sps.inter_frame_prediction_enabled_flag)
        aps.inter_frame_prediction_enabled_flag
      if(sps.entropy_continuation_enabled_flag){
        aps.entropy_continuation_enabled_flag
        if(aps.entropy_continuation_enabled_flag){
          aps.intra_entropy_continuation_enabled_flag
          if(aps.inter_frame_prediction_enabled_flag)
            aps.inter_entropy_continuation_enabled_flag
        }
      }
}
```

Furthermore, in some embodiments of the present disclosure, if the value of the fourth entropy continuation enabled flag is the twenty-first value, or the value of the fourth inter-frame prediction enabled flag is the twenty-third value, the determination process of the fourth inter entropy continuation enabled flag is not performed.

Furthermore, in an embodiment of the present disclosure, since the first reordering flag and entropy continuation are exclusive, a verification processing may be performed according to the first reordering flag and the fourth entropy continuation enabled flag. Specifically, an assertion check may be performed according to the first reordering flag and the fourth entropy continuation enabled flag.

Exemplarily, in an embodiment of the present disclosure, the process of performing verification processing according to the first reordering flag and the fourth entropy continuation enabled flag described above may be expressed as follows:

if (aps.entropy_continuation_enabled_flag)
assert(sps.profile.slice_reordering_constraint_flag)

Step 105, the fifth flag information corresponding to the current processing unit is determined according to the fourth flag information, and an attribute prediction value corresponding to the current processing unit is obtained according to the fifth flag information. The fifth flag information is flag information corresponding to the attribute brick header information.

In an embodiment of the present disclosure, after determining the fourth flag information corresponding to the current processing unit according to the first flag information, the fifth flag information corresponding to the current processing unit may be determined according to the fourth flag information, and the attribute prediction value corresponding to the current processing unit may be obtained according to the fifth flag information. The fifth flag information is the flag information corresponding to the attribute brick header information.

Furthermore, in an embodiment of the present disclosure, the fifth flag information may contain at least a fifth inter-frame prediction enabled flag, a fifth entropy continuation enabled flag, and a fifth inter entropy continuation mode flag.

Furthermore, in an embodiment of the present disclosure, the fifth inter-frame prediction enabled flag is an ABH-layer inter-frame prediction enabled flag (abh.inter_frame_prediction_enabled_flag), the fifth entropy continuation enabled flag is an ABH-layer entropy continuation enabled flag abh.entropy_continuation_enabled_flag, and the fifth inter entropy continuation mode flag is an ABH-layer inter entropy continuation mode flag.

It can be understood that in an embodiment of the present disclosure, the fifth inter-frame prediction enabled flag is used for determining whether dependency between different frames is allowed in the attribute brick header information. The fifth entropy continuation enabled flag is used for determining whether a reference entropy coding probability model is allowed to be used in the attribute brick header information. The fifth inter-frame prediction enabled flag is used for determining whether a reference entropy coding probability model of a different frame is allowed to be used in the attribute brick header information. The fifth inter entropy continuation mode flag is used for determining a source of the entropy coding probability model of the current processing unit.

Furthermore, in an embodiment of the present disclosure, the following table defines the fifth flag information, i.e., ABS-layer syntax elements of a slice and corresponding descriptors.

TABLE 6

| | Syntax Element | Meaning | Descriptor |
|---|---|---|---|
| ABH | abh.inter_frame_prediction_enabled_flag | ABH-layer inter-frame | u(1) |
| | | prediction enabled flag | |
| | abh.entropy_continuation_enabled_flag | ABH-layer entropy | u(1) |
| | | continuation enabled flag | |
| | abh.entropy_continuation_mode | ABH-layer inter entropy | u(2) |
| | | continuation mode (0: | |
| | | Discontinuous; 1: Slice- | |
| | | continuous; 2: Inter | |
| | | continuous) | |
| | abh. entropy_continuation_slice_id | ABH-layer entropy | ue(v) |
| | | continuation reference | |
| | | slice index | |

Among the above descriptors, u (n) indicates reading consecutive n bit(s), and a decoded value of the n bit(s) is an unsigned integer. Ue (v) indicates an unsigned exponential-Golomb entropy coding syntax element.

It should be noted that in an embodiment of the present disclosure, the fifth flag information is similar to the third flag information, with a difference in that the fifth flag information does not need to store the index value of the current processing unit, i.e., cur_slice_id, but shares with the GBH-layer.

Furthermore, in an embodiment of the present disclosure, when determining the fifth flag information corresponding to the current processing unit according to the fourth flag information, if the value of the fourth inter-frame prediction enabled flag is the twenty-second value, the bitstream is decoded to determine the fifth inter-frame prediction enabled flag.

Exemplarily, in an embodiment of the present disclosure, if aps.inter_frame_prediction_enabled_flag (the fourth inter-frame prediction enabled flag) is true (the twenty-second value), abh.inter_frame_prediction_enabled_flag (the fifth inter-frame prediction enabled flag) is decoded.

Furthermore, in some embodiments of the present disclosure, if the value of the fourth inter-frame prediction enabled flag is the twenty-third value (false), a determination process of the fifth inter-frame prediction enabled flag is not performed.

Furthermore, in some embodiments of the present disclosure, the fourth inter entropy continuation enabled flag may be a twenty-fourth value or a twenty-fifth value. For example, the twenty-fourth value may be false, and the twenty-fifth value may be true.

Furthermore, in some embodiments of the present disclosure, when determining the fifth flag information corresponding to the current processing unit according to the fourth flag information, if the value of the fourth entropy continuation enabled flag is the twentieth value, the bitstream is decoded to determine the fifth entropy continuation enabled flag and the fifth inter entropy continuation mode flag.

Exemplarily, in an embodiment of the present disclosure, if aps.entropy_continuation_enabled_flag (the fourth entropy continuation enabled flag) is true (the twentieth value), abh.entropy_continuation_enabled_flag (the fifth entropy continuation enabled flag) and abh.entropy_continuation_mode (the fifth inter entropy continuation mode flag) are decoded.

Furthermore, in some embodiments of the present disclosure, if the value of the fourth entropy continuation enabled flag is the twenty-first value, a determination process of the fifth entropy continuation enabled flag and a determination process of the fifth inter entropy continuation mode flag are not performed.

Furthermore, in an embodiment of the present disclosure, a probability model corresponding to attribute information may be determined according to the fifth flag information, so that an attribute prediction value is obtained according to the probability model corresponding to the attribute information.

It can be understood that in an embodiment of the present disclosure, the probability model corresponding to the attribute information is a probability model used when determining the attribute prediction value of the current processing unit.

Furthermore, in some embodiments of the present disclosure, the probability model corresponding to the attribute information may be determined according to the fifth inter entropy continuation mode flag.

Furthermore, in some embodiments of the present disclosure, if a value of the fifth entropy continuation enabled flag is a twenty-sixth value (true), the probability model corresponding to the attribute information is determined according to the index value of the current processing unit.

Furthermore, in some embodiments of the present disclosure, the fifth entropy continuation enabled flag may be the twenty-sixth value or a twenty-seventh value. For example, the twenty-sixth value is true, and the twenty-seventh value is false.

Furthermore, in some embodiments of the present disclosure, if the value of the fifth entropy continuation enabled flag is the twenty-seventh value, a determination process of the fifth inter entropy continuation mode flag is not performed.

Exemplarily, a decoding process of the ABH parameters described above may be expressed as follows:

```
parseABH( ){
  if(aps.inter_frame_prediction_enabled_flag)
    abh.inter_frame_prediction_enabled_flag
  if(aps.entropy_continuation_enabled_flag){
    abh.entropy_continuation_mode
    if(abh.entropy_continuation_mode == 1){
      abh. entropy_continuation_slice_id
    else if(abh.entropy_continuation_mode!=0)
      abh. entropy_continuation_slice_id
    }
  }
}
```

Furthermore, in some embodiments of the present disclosure, when determining the probability model corresponding to the attribute information according to the index value of the current processing unit, the fifth inter entropy continuation mode flag may be determined based on the index value of the current processing unit. The probability model corresponding to the attribute information is determined according to the fifth inter entropy continuation mode flag.

Furthermore, in some embodiments of the present disclosure, when determining the probability model corresponding to the attribute information according to the fifth inter entropy continuation mode flag, if a value of the fifth inter entropy continuation mode flag is a twenty-eighth value (0), the probability model corresponding to the attribute information of the current processing unit is initialized. If the value of the fifth inter entropy continuation mode flag is a twenty-ninth value (1), the probability model corresponding to the attribute information of the current processing unit is determined according to a probability model corresponding to a fifth reference unit, where the fifth reference unit and the current processing unit belong to the same frame. If the value of the fifth inter entropy continuation mode flag is a thirtieth value (2), the probability model corresponding to the attribute information of the current processing unit is determined according to a probability model corresponding to a sixth reference unit, where the sixth reference unit is in a frame immediately previous to a frame containing the current processing unit.

Furthermore, in an embodiment of the present disclosure, for the first scenario, after all flag information is decoded, verification needs to be performed on results of the fifth inter-frame prediction enabled flag and the fifth inter entropy continuation mode flag. It is necessary to determine that two cases where the fifth inter-frame prediction enabled flag is false and where the fifth inter entropy continuation mode flag is 2 do not occur simultaneously.

The following describes a decoding process in the second scenario.

In an embodiment of the present disclosure, for the decoding process in the second scenario, when determining the probability model corresponding to the attribute information of the current processing unit according to the fifth flag information, if the value of the fifth entropy continuation enabled flag is the twenty-sixth value (true), the probability model corresponding to the attribute information is determined according to the index value of the current processing unit.

Furthermore, in some embodiments of the present disclosure, if the value of the fifth entropy continuation enabled flag is the twenty-seventh value, the determination process of the fifth inter entropy continuation mode flag is not performed.

Furthermore, in some embodiments of the present disclosure, when determining the probability model corresponding to the attribute information according to the index value of the current processing unit, the fifth inter entropy continuation mode flag may be determined based on the index value of the current processing unit. The probability model corresponding to the attribute information is determined according to the fifth inter entropy continuation mode flag.

Furthermore, in some embodiments of the present disclosure, when determining the fifth inter entropy continuation mode flag based on the index value of the current processing unit, if the index value of the current processing unit is the twelfth value and a value of the fifth inter-frame prediction enabled flag is a thirty-first value, the bitstream is decoded to determine the fifth inter entropy continuation mode flag.

Furthermore, in some embodiments of the present disclosure, the fifth inter-frame prediction enabled flag may be the thirty-first value or a thirty-second value. For example, the thirty-first value is true, and the thirty-second value is false.

Furthermore, in some embodiments of the present disclosure, if the index value of the current processing unit is not the twelfth value, the bitstream is decoded to determine the fifth inter entropy continuation mode flag.

Furthermore, in some embodiments of the present disclosure, if the index value of the current processing unit is the twelfth value and the fifth inter-frame prediction enabled flag is not the thirty-first value, the determination process of the fifth inter entropy continuation mode flag is not performed. The value of the fifth inter entropy continuation mode flag is determined as the twenty-eighth value.

Furthermore, in some embodiments of the present disclosure, the fifth inter entropy continuation mode flag may be one of the twenty-eighth value, the twenty-ninth value, and the thirtieth value. For example, the twenty-eighth value is 0, the twenty-ninth value is 1, and the thirtieth value is 2.

Exemplarily, in an embodiment of the present disclosure, in the second scenario described above, a decoding method of the ABH-layer flag information may be expressed as follows:

```
parseABH( ){
  if(aps.inter_frame_prediction_enabled_flag)
    abh.inter_frame_prediction_enabled_flag
  if(aps.entropy_continuation_enabled_flag){
    abh.entropy_continuation_enabled_flag
    if(abh.entropy_continuation_enabled_flag){
      if(cur_slice_id==0)
        if(aps.inter_frame prediction_enabled_flag)
          abh.entropy_continuation_mode
      else
        abh.entropy_continuation_mode
    }
}
```

Furthermore, in an embodiment of the present disclosure, for the second scenario, when determining the probability model corresponding to the attribute information according to the fifth inter entropy continuation mode flag, if the value of the fifth inter entropy continuation mode flag is the twenty-eighth value, the probability model corresponding to the attribute information of the current processing unit is initialized. If the value of the fifth inter entropy continuation mode flag is the twenty-ninth value, the probability model corresponding to the attribute information of the current processing unit is determined according to a probability model corresponding to a seventh reference unit, where the seventh reference unit is a processing unit immediately previous to the current processing unit. The seventh reference unit and the current processing unit belong to the same frame or different frames.

In some embodiments of the present disclosure, in the second scenario, after the fifth inter entropy continuation mode flag is obtained through decoding, a corresponding operation may be performed according to the result of the fifth inter entropy continuation mode flag. If the value of the fifth inter entropy continuation mode flag is 0 (the twenty-eighth value), the slice does not inherit a convergent probability value from an entropy model of another slice, and a probability model required for the entropy coding process is initialized. If the value of the fifth inter entropy continuation mode flag is 1 (the twenty-ninth value), the slice needs to inherit a probability model from an immediately previous slice of the current slice in a decoding order. If the current slice is not the first slice of a current frame, the current slice inherits an entropy model of the immediately previous slice in the current frame. If the current slice is the first slice of the current frame, the current slice inherits an entropy model of a last slice in the immediately previous frame.

The following describes a decoding process in the third scenario.

Exemplarily, in an embodiment of the present disclosure, for the decoding process in the third scenario, similarly, the SPS-layer inter-frame prediction enabled flag sps.inter_frame_prediction_enabled_flag (the first inter-frame prediction enabled flag) and the SPS-layer entropy continuation enabled flag sps.entropy_continuation_enabled_flag (the first entropy continuation enabled flag) may be decoded first.

Furthermore, in some embodiments of the present disclosure, the decoding process in the third scenario is similar to the decoding process in the first scenario.

Furthermore, in some embodiments of the present disclosure, when determining the fourth flag information according to the first flag information, if the value of the first entropy continuation enabled flag is the first value and the value of the fourth inter-frame prediction enabled flag is the twenty-second value, the bitstream is decoded to determine the fourth entropy continuation enabled flag.

Exemplarily, in an embodiment of the present disclosure, if sps.entropy_continuation_enabled_flag (the first entropy continuation enabled flag) is true (the first value) and aps.inter_frame_prediction_enabled_flag (the fourth inter-frame prediction enabled flag) is true, aps.entropy_continuation_enabled_flag (the fourth entropy continuation enabled flag) is decoded. Otherwise, aps.entropy_continuation_enabled_flag is defaulted to false. The process can be expressed as follows:

```
parseAPS( ){
  if(sps.inter_frame_prediction_enabled_flag){
    aps.inter_frame_prediction_enabled_flag
    if(sps.entropy_continuation_enabled_flag)
      aps.entropy_continuation_enabled_flag
  }
}
```

Furthermore, in some embodiments of the present disclosure, if the value of the first entropy continuation enabled flag is the third value, or the value of the fourth inter-frame prediction enabled flag is the twenty-third value, the determination process of the fourth entropy continuation enabled flag is not performed.

Furthermore, in some embodiments of the present disclosure, when determining the fifth flag information according to the fourth flag information, if the value of the fourth inter entropy continuation enabled flag is the twenty-fifth value, the bitstream is decoded to determine the fifth inter-frame prediction enabled flag. If the value of the fourth inter entropy continuation enabled flag is the twenty-fourth value, the determination process of the fifth inter-frame prediction enabled flag is not performed.

Furthermore, in some embodiments of the present disclosure, when determining the fifth flag information according to the fourth flag information, if the value of the fourth entropy continuation enabled flag is the twentieth value and the value of the fourth inter entropy continuation enabled flag is the twenty-fifth value, the bitstream is decoded to determine the fifth entropy continuation enabled flag. If the value of the fourth entropy continuation enabled flag is the twenty-first value, or the value of the fourth inter entropy continuation enabled flag is the twenty-fourth value, the determination process of the fifth entropy continuation enabled flag is not performed.

Furthermore, in some embodiments of the present disclosure, if the value of the fifth entropy continuation enabled flag is the twenty-sixth value and the value of the fifth inter-frame prediction enabled flag is the thirty-first value, the bitstream is decoded to determine the fifth inter entropy continuation mode flag. The probability model corresponding to the attribute information of the current processing unit is determined according to the fifth inter entropy continuation mode flag.

Exemplarily, in an embodiment of the present disclosure, the decoding process of the fifth flag information described above may be expressed as follows:

```
    parseABH( ){
      if(aps.inter_frame_prediction_enabled_flag){
        abh.inter_frame_prediction_enabled_flag
        if(aps.entropy_continuation_enabled_flag &&
abh.inter_frame_prediction_enabled_flag){
          abh.entropy_continuation_enabled_flag
          if(abh.entropy_continuation_enabled_flag)
            abh.entropy_continuation_mode
            if(abh.entropy_continuation_mode==1)
              abh.entropy_continuation_slice_id
        }
      }
    }
```

Furthermore, in some embodiments of the present disclosure, if the value of the fifth entropy continuation enabled flag is the twenty-seventh value, or the value of the fifth inter-frame prediction enabled flag is the thirty-second value (false), the determination process of the fifth inter entropy continuation mode flag is not performed.

Furthermore, in an embodiment of the present disclosure, for the third scenario, a source of an entropy encoding/decoding probability model stored for the current slice may also be determined according to the value of the fifth inter entropy continuation mode flag.

Furthermore, in some embodiments of the present disclosure, for the third scenario, if the value of the fifth inter entropy continuation mode flag is the twenty-eighth value, the probability model corresponding to the attribute information of the current processing unit is initialized. If the value of the fifth inter entropy continuation mode flag is the twenty-ninth value, the probability model corresponding to the attribute information of the current processing unit is determined according to a probability model corresponding to an eighth reference unit. The eighth reference unit is in a frame immediately previous to a frame containing the current processing unit.

Furthermore, in an embodiment of the present disclosure, in the decoding processes in the above three scenarios, when initializing the probability model corresponding to the current processing unit, an assignment processing can be performed on a probability value corresponding to the probability model complete the initialization.

The embodiment of the present disclosure provides a point cloud decoding method. At the decoding end, the bitstream is decoded to determine the first flag information corresponding to the current processing unit. The first flag information is the flag information corresponding to the sequence parameter set. According to the first flag information, the second flag information corresponding to the current processing unit is determined. The second flag information is the flag information corresponding to the geometry parameter set. The probability model is determined based on the second flag information, and the prediction value of the current processing unit is obtained according to the probability model. In this way, during the decoding process of the current processing unit, the second flag information corresponding to the current processing unit can be controlled by determining the first flag information corresponding to the current processing unit, and the inheritance of the entropy continuation enabled flag can be clarified. Therefore, the decoding operations can be simplified and the decoding performance of the point cloud can be improved.

An embodiment of the disclosure provides a point cloud encoding method. FIG. 19 illustrates a schematic diagram of an implementation process of the point cloud encoding method provided in an embodiment of the disclosure. As illustrated in FIG. 19, the encoding process of the point cloud may include the following steps.

Step 201, first flag information corresponding to a current processing unit is determined, and the first flag information is signalled into a bitstream. The first flag information is flag information corresponding to a sequence parameter set.

In an embodiment of the disclosure, the first flag information corresponding to the current processing unit may be determined first, and the first flag information is signalled into the bitstream. The first flag information is the flag information corresponding to the sequence parameter set.

It should be noted that the encoding method described in embodiments of the disclosure specifically refers to a point cloud encoding method, which may be applied to a point cloud encoder (also referred to as “encoder” for short).

It should be noted that in embodiments of the disclosure, a to-be-processed point cloud may contain at least one to-be-processed unit. During encoding of any one unit among the to-be-processed units, the unit may serve as the current processing unit in the to-be-processed point cloud. The current processing unit is a to-be-encoded unit that needs to be encoded currently among the at least one unit.

Furthermore, in embodiments of the disclosure, each to-be-processed unit in the to-be-processed point cloud corresponds to geometry information and attribute information. The geometry information represents a spatial relationship of the unit, and the attribute information represents information related to attribute of the unit.

The attribute information may be color information, reflectance, or other attributes, which is not specifically limited in embodiments of the disclosure. When the attribute information is color information, the attribute information may specifically be color information in any color space. Exemplarily, the attribute information may be color information in RGB space, color information in YUV space, or color information in YCbCr space, etc., which is also not specifically limited in embodiments of the disclosure.

Exemplarily, in embodiments of the disclosure, the current processing unit may be a slice to be currently encoded.

Furthermore, in embodiments of the disclosure, tile partitioning and slice partitioning in G-PCC may be performed.

Furthermore, in embodiments of the disclosure, the first flag information is the flag information corresponding to a sequence parameter set.

Exemplarily, in the embodiment of the disclosure, Table 2 defines SPS-layer syntax elements and descriptors corresponding to the syntax elements, where a descriptor refers to an entropy encoding algorithm for a syntax element.

It should be noted that in embodiments of the disclosure, encoding process in three scenarios is supported. In a first scenario, storage of a probability model of any slice in a reference frame and a current frame is allowed for inheritance by a current encoding slice, and sps.profile.slice_reordering_constraint_flag is obtained through parameter configuration or an encoder-end decision algorithm and is signalled into the bitstream. In a second scenario, storage of a probability model of any slice is not allowed, and only a probability model of an immediately previous slice can be inherited. Bitstream reordering of slices is not allowed, that is, an order of slices remains consistent during the encoding. In a third scenario, storage of the probability model of any slice in the reference frame and the current frame is allowed for inheritance by each slice, and slice reordering is allowed, that is, sps.profile.slice_reordering_constraint_flag is false. Orders of slices during encoding process may not be completely consistent. In the third scenario, only inter entropy continuation is allowed, while intra entropy continuation is not allowed.

The following describe an encoding process in the first scenario.

Furthermore, in an embodiment of the disclosure, the first flag information is flag information corresponding to the SPS-layer, and may contain a first entropy continuation enabled flag, a first inter-frame prediction enabled flag, a first intra entropy continuation enabled flag, and a first inter entropy continuation enabled flag.

Furthermore, in an embodiment of the disclosure, the first inter-frame prediction enabled flag is used for determining whether dependency between different frames is allowed in the sequence parameter set. The first entropy continuation enabled flag is used for determining whether a reference entropy coding probability model is allowed to be used in the sequence parameter set. The first intra entropy continuation enabled flag is used for determining whether an intra reference entropy coding probability model is allowed to be used in the sequence parameter set. The first inter entropy continuation enabled flag is used for determining whether a reference entropy coding probability model of a different frame is allowed to be used in the sequence parameter set.

Furthermore, in an embodiment of the disclosure, the first entropy continuation enabled flag is a SPS-layer entropy continuation enabled flag sps.entropy_continuation_enabled_flag. The first inter-frame prediction enabled flag is a SPS-layer inter-frame prediction enabled flag sps.inter_frame_prediction_enabled_flag. The first intra entropy continuation enabled flag is a SPS-layer sps.intra_entropy_continuation_enabled_flag. The first inter entropy continuation enabled flag is a SPS-layer inter entropy continuation enabled flag sps.inter_entropy_continuation_enabled_flag.

Furthermore, in an embodiment of the disclosure, the first inter-frame prediction enabled flag and a first reordering flag may be determined, and the first inter-frame prediction enabled flag and the first reordering flag are signalled into the bitstream. If a value of the first reordering flag is a thirty-third value, the first entropy continuation enabled flag is determined, and the first entropy continuation enabled flag is signalled into the bitstream. If a value of the first entropy continuation enabled flag is a first value, the first intra entropy continuation enabled flag is determined, and the first intra entropy continuation enabled flag is signalled into the bitstream. If the value of the first entropy continuation enabled flag is the first value and a value of the first inter-frame prediction enabled flag is a second value, the first inter entropy continuation enabled flag is determined, and the first inter entropy continuation enabled flag is signalled into the bitstream.

In an embodiment of the disclosure, the thirty-third value may be 1.

Furthermore, in an embodiment of the disclosure, if the value of the first reordering flag is a thirty-fourth value (0), the first entropy continuation enabled flag is determined as a third value (false), or a value of the first intra entropy continuation enabled flag is determined as a thirty-fifth value (false), or the value of the first inter-frame prediction enabled flag is determined as a fourth value (false), or a value of the first inter entropy continuation enabled flag is determined as a thirty-sixth value (false).

It should be noted that in an embodiment of the disclosure, at an encoder end, the first flag information may be determined according to a profile, and the first flag information is signalled into the bitstream. Second flag information is determined according to the profile and the first flag information, and the second flag information is signalled into the bitstream. Third flag information is determined according to the second flag information, and the third flag information is signalled into the bitstream.

Furthermore, in an embodiment of the disclosure, for an encoding process in the first scenario, the first entropy continuation enabled flag and the first inter-frame prediction enabled flag may be determined, and the first entropy continuation enabled flag and the first inter-frame prediction enabled flag are signalled into the bitstream. If the value of the first entropy continuation enabled flag is the first value, the first intra entropy continuation enabled flag is determined, and the first intra entropy continuation enabled flag is signalled into the bitstream. If the value of the first entropy continuation enabled flag is the first value and the value of the first inter-frame prediction enabled flag is the second value, the first inter entropy continuation enabled flag is determined, and the first inter entropy continuation enabled flag is signalled into the bitstream.

Furthermore, in some embodiments of the disclosure, if the value of the first entropy continuation enabled flag is the third value, the first intra entropy continuation enabled flag is not signalled into the bitstream.

Furthermore, in some embodiments of the disclosure, if the value of the first entropy continuation enabled flag is the third value, or the value of the first inter-frame prediction enabled flag is the fourth value, the first inter entropy continuation enabled flag is not signalled into the bitstream.

Exemplarily, in an embodiment of the disclosure, configuration parameters may first be read from the profile: the SPS-layer inter-frame prediction enabled flag sps.inter_frame_prediction_enabled_flag, the SPS-layer entropy continuation enabled flag sps.entropy_continuation_enabled_flag, the SPS-layer inter entropy continuation enabled flag sps.inter_entropy_continuation_enabled_flag, and the SPS-layer intra entropy continuation enabled flag sps.intra_entropy_continuation_enabled_flag. Then, sps.inter_frame_prediction_enabled_flag (the first inter-frame prediction enabled flag) and sps.entropy_continuation_enabled_flag (the first entropy continuation enabled flag) are encoded. If sps.inter_frame_prediction_enabled_flag (the first inter-frame prediction enabled flag) is false (the fourth value), or the sps.entropy_continuation_enabled_flag (the first entropy continuation enabled flag) is false (the third value), sps.inter_entropy_continuation_enabled_flag does not need to be encoded and is set to false in subsequent processes. Otherwise, a value of sps.inter_entropy_continuation_enabled_flag is encoded. If sps.entropy_continuation_enabled_flag (the first entropy continuation enabled flag) is false (the third value), sps.intra_entropy_continuation_enabled_flag (the first intra entropy continuation enabled flag) does not need to be encoded and is set to false in subsequent determinations. Otherwise, a value of sps.intra_entropy_continuation_enabled_flag (the first intra entropy continuation enabled flag) is encoded.

Furthermore, in some embodiments of the disclosure, when determining the first flag information corresponding to the current processing unit and signalling the first flag information into the bitstream, the first inter-frame prediction enabled flag and the first intra entropy continuation enabled flag may be determined, and the first inter-frame prediction enabled flag and the first intra entropy continuation enabled flag are signalled into the bitstream. If the value of the first inter-frame prediction enabled flag is the second value, the first inter entropy continuation enabled flag is determined, and the first inter entropy continuation enabled flag is signalled into the bitstream.

Furthermore, in some embodiments of the disclosure, the first flag information further contains the first reordering flag, and the first reordering flag may also be determined and signalled into the bitstream. The first reordering flag is used for determining whether bitstream reordering is constrained.

Exemplarily, in an embodiment of the disclosure, sps.profile.slice_reordering_constraint_flag (the first reordering flag) is encoded, and a value of the syntax element is obtained through input configuration or the encoder-end decision algorithm.

Exemplarily, in an embodiment of the disclosure, when sps.entropy_continuation_enabled_flag (the first entropy continuation enabled flag) is enabled, dependencies may exist between slices. In this case, an order of slice bitstreams should not be disrupted. For example, sps.profile.slice_reordering_constraint_flag is determined by sps.entropy_continuation_enabled_flag, which can be expressed as:
sps.profile.slice_reordering_constraint_flag=sps.entropy_continuation_enabled_flag

Furthermore, in some embodiments of the disclosure, the first reordering flag and the first inter entropy continuation enabled flag are used for performing verification processing.

Furthermore, in some embodiments of the disclosure, the first reordering flag and the first entropy continuation enabled flag are used for performing the verification processing.

Step 202, second flag information corresponding to the current processing unit is determined according to the first flag information, and the second flag information is signalled into the bitstream. The second flag information is flag information corresponding to a geometry parameter set.

In an embodiment of the disclosure, after determining the first flag information corresponding to the current processing unit and signalling the first flag information into the bitstream, the second flag information corresponding to the current processing unit may be determined according to the first flag information, and the second flag information is signalled into the bitstream. The second flag information is the flag information corresponding to the geometry parameter set.

Furthermore, in an embodiment of the disclosure, the second flag information may contain a second inter-frame prediction enabled flag and a second entropy continuation enabled flag. When determining the second flag information corresponding to the current processing unit according to the first flag information, the second inter-frame prediction enabled flag may be determined according to the first inter-frame prediction enabled flag. The second entropy continuation enabled flag may be determined according to the first entropy continuation enabled flag.

Furthermore, in an embodiment of the disclosure, the first reordering flag and the second entropy continuation enabled flag are used for performing the verification processing.

Furthermore, in an embodiment of the disclosure, the second inter-frame prediction enabled flag is a GPS-layer inter-frame prediction enabled flag gps.inter_frame_prediction_enabled_flag. The second entropy continuation enabled flag is a GPS-layer entropy continuation enabled flag gps.entropy_continuation_enabled_flag. The second inter entropy continuation enabled flag is a GPS-layer inter entropy continuation enabled flag gps.inter_entropy_continuation_enabled_flag.

Furthermore, in an embodiment of the disclosure, the second inter-frame prediction enabled flag is used for determining whether dependency between different frames is allowed in the geometry parameter set. The second entropy continuation enabled flag is used for determining whether a reference entropy coding probability model is allowed to be used in the geometry parameter set. The second inter entropy continuation enabled flag is used for determining whether a reference entropy coding probability model of a different frame is allowed to be used in the geometry parameter set. The second intra entropy continuation enabled flag is used for determining whether an intra reference entropy coding probability model is allowed to be used in the geometry parameter set.

Furthermore, in an embodiment of the disclosure, Table 3 defines GPS-layer syntax elements (i.e., the second flag information) and corresponding descriptors in the disclosure.

Furthermore, in some embodiments of the disclosure, when determining the second inter-frame prediction enabled flag according to the first inter-frame prediction enabled flag, if the value of the first inter-frame prediction enabled flag is the second value, the second inter-frame prediction enabled flag is determined.

Furthermore, in some embodiments of the disclosure, if the value of the first inter-frame prediction enabled flag is the fourth value, the second inter-frame prediction enabled flag is not signalled into the bitstream.

Furthermore, in some embodiments of the disclosure, when determining the second entropy continuation enabled flag according to the first entropy continuation enabled flag, if the value of the first entropy continuation enabled flag is the first value, the second entropy continuation enabled flag is determined.

Furthermore, in some embodiments of the disclosure, if the value of the first entropy continuation enabled flag is the third value, the second entropy continuation enabled flag is not signalled into the bitstream.

Furthermore, in some embodiments of the disclosure, if the value of the first inter-frame prediction enabled flag is the fourth value, or the value of the first entropy continuation enabled flag is the third value, the second inter entropy continuation enabled flag is not signalled into the bitstream.

Furthermore, in some embodiments of the disclosure, the second flag information further contains the second intra entropy continuation enabled flag. If a value of the second entropy continuation enabled flag is a fifth value, the second intra entropy continuation enabled flag is determined. If the value of the second entropy continuation enabled flag is a sixth value, the second intra entropy continuation enabled flag is not signalled into the bitstream.

Furthermore, in some embodiments of the disclosure, the second flag information further contains the second inter entropy continuation enabled flag. If the value of the second entropy continuation enabled flag is the fifth value and a value of the second inter-frame prediction enabled flag is a seventh value, the second inter entropy continuation enabled flag is determined and signalled into the bitstream. If the value of the second entropy continuation enabled flag is the sixth value, or the value of the second inter-frame prediction enabled flag is an eighth value, the second inter entropy continuation enabled flag is not signalled into the bitstream.

Exemplarily, in an embodiment of the disclosure, the GPS-layer inter-frame prediction enabled flag gps.inter_frame_prediction_enabled_flag, the GPS-layer entropy continuation enabled flag gps.entropy_continuation_enabled_flag, the GPS-layer inter entropy continuation enabled flag gps.inter_entropy_continuation_enabled_flag, and a GPS-layer intra entropy continuation enabled flag gps.intra_entropy_continuation_enabled_flag in the profile may be read, and encoding is performed according to the value of the flag information (i.e., the second flag information) corresponding to the GPS-layer.

Exemplarily, in an embodiment of the disclosure, if the sps.inter_frame_prediction_enabled_flag (the first inter-frame prediction enabled flag) is false (the fourth value), gps.inter_frame_prediction_enabled_flag (the second inter-frame prediction enabled flag) does not need to be encoded and is set to false in subsequent processes. Otherwise, the value of gps.inter_frame_prediction_enabled_flag is encoded.

Exemplarily, in an embodiment of the disclosure, if sps.entropy_continuation_enabled_flag (the first entropy continuation enabled flag) is false, gps.entropy_continuation_enabled_flag (the second entropy continuation enabled flag) does not need to be encoded and is set to false in subsequent processes. Otherwise, the value of gps.entropy_continuation_enabled_flag is encoded.

Exemplarily, in an embodiment of the disclosure, if sps.inter_frame_prediction_enabled_flag (the first inter-frame prediction enabled flag) is false (the fourth value) or sps.entropy_continuation_enabled_flag (the first entropy continuation enabled flag) is false (the third value), gps.inter_entropy_continuation_enabled_flag (the second inter entropy continuation enabled flag) does not need to be encoded and is set to false in subsequent processes. Otherwise, the value of gps.inter_entropy_continuation_enabled_flag is encoded. If sps.entropy_continuation_enabled_flag (the first entropy continuation enabled flag) is false, gps.intra_entropy_continuation_enabled_flag (the second intra entropy continuation enabled flag) does not need to be encoded and is set to false in subsequent processes.

Step 203, a probability model corresponding to the current processing unit is determined based on the second flag information, and a prediction value of the current processing unit is obtained according to the probability model.

In an embodiment of the disclosure, after determining the second flag information corresponding to the current processing unit according to the first flag information and signalling the second flag information into the bitstream, the probability model corresponding to the current processing unit may be determined based on the second flag information, and the prediction value of the current processing unit may be obtained according to the probability model.

Furthermore, in an embodiment of the disclosure, when determining the probability model based on the second flag information, third flag information corresponding to the current processing unit may be determined according to the second flag information. The third flag information is flag information corresponding to geometry brick header (GBH) information. Then the probability model corresponding to the current processing unit is determined according to the third flag information.

Furthermore, in an embodiment of the disclosure, the third inter-frame prediction enabled flag is a GBH-layer inter-frame prediction enabled flag gbh.inter_frame_prediction_enabled_flag. The third entropy continuation enabled flag is a GBH-layer entropy continuation enabled flag gbh.entropy_continuation_enabled_flag. The third inter entropy continuation mode flag is a GBH-layer inter entropy continuation mode flag gbh.entropy_continuation_mode.

Furthermore, in an embodiment of the disclosure, the third inter-frame prediction enabled flag is used for determining whether dependency between different frames is allowed in the geometry brick header information. The third entropy continuation enabled flag is used for determining whether a reference entropy coding probability model is allowed to be used in the geometry brick header information. The third inter-frame prediction enabled flag is used for determining whether a reference entropy coding probability model of a different frame is allowed to be used in the geometry brick header information. The third inter entropy continuation mode flag is used for determining a source of the entropy coding probability model of the current processing unit.

Furthermore, in an embodiment of the disclosure, Table 4 defines the third flag information in the disclosure, that is, GBH-layer syntax elements of a slice and corresponding descriptors of the syntax elements.

Furthermore, in some embodiments of the disclosure, the third flag information contains the third inter-frame prediction enabled flag. When determining the third flag information corresponding to the current processing unit according to the second flag information, if the value of the second inter-frame prediction enabled flag is the seventh value, the third inter-frame prediction enabled flag is determined.

Furthermore, in some embodiments of the disclosure, if the value of the second inter-frame prediction enabled flag is the eighth value, the third inter-frame prediction enabled flag is not signalled into the bitstream.

Furthermore, in some embodiments of the disclosure, if a value of the second inter entropy continuation enabled flag is a ninth value, the third inter-frame prediction enabled flag is not signalled into the bitstream.

Furthermore, in some embodiments of the disclosure, the third flag information further contains the third entropy continuation enabled flag and the third inter entropy continuation mode flag. When determining the third flag information corresponding to the current processing unit according to the second flag information, if the value of the second entropy continuation enabled flag is the fifth value, the third entropy continuation enabled flag and the third inter entropy continuation mode flag are determined.

Furthermore, in some embodiments of the disclosure, if the value of the second entropy continuation enabled flag is the sixth value, the third entropy continuation enabled flag and the third inter entropy continuation mode flag are not signalled into the bitstream.

Furthermore, in some embodiments of the disclosure, the probability model corresponding to the current processing unit may be determined according to the third inter entropy continuation mode flag.

Furthermore, in some embodiments of the disclosure, for the first scenario, when determining the probability model corresponding to the current processing unit according to the third inter entropy continuation mode flag, if a value of the third inter entropy continuation mode flag is a fourteenth value, the probability model corresponding to the current processing unit is initialized. If the value of the third inter entropy continuation mode flag is a seventeenth value, the probability model corresponding to the current processing unit is determined according to a probability model corresponding to a first reference unit, where the first reference unit and the current processing unit belong to the same frame. If the value of the third inter entropy continuation mode flag is an eighteenth value, the probability model corresponding to the current processing unit is determined according to a probability model corresponding to a second reference unit, where the second reference unit is in a frame immediately previous to a frame containing the current processing unit.

Exemplarily, in an embodiment of the disclosure, gbh.inter_frame_prediction_enabled_flag (the third inter-frame prediction enabled flag) and gbh.entropy_continuation_enabled_flag (the third entropy continuation enabled flag) may be determined according to the values of gps.inter_frame_prediction_enabled_flag (the second inter-frame prediction enabled flag), gps.entropy_continuation_enabled_flag (the second entropy continuation enabled flag), gps.inter_entropy_continuation_enabled_flag (the second inter entropy continuation enabled flag), gps.intra_entropy_continuation_enabled_flag (the second intra entropy continuation enabled flag), and a determination algorithm.

Exemplarily, in an embodiment of the disclosure, if gps.inter_entropy_continuation_enabled_flag (the second inter entropy continuation enabled flag) is false, gbh.inter_frame_prediction_enabled_flag (the third inter-frame prediction enabled flag) does not need to be encoded and is set to false in subsequent processes. Otherwise, the value of gbh.inter_frame_prediction_enabled_flag is determined and encoded. If gps.entropy_continuation_enabled_flag (the second entropy continuation enabled flag) is false, gbh.entropy_continuation_enabled_flag (the third entropy continuation enabled flag) does not need to be encoded and is set to false in subsequent processes. Otherwise, the value of gbh.entropy_continuation_enabled_flag is determined and encoded.

Exemplarily, in an embodiment of the disclosure, the value of gbh.entropy_continuation_mode (the third inter entropy continuation mode flag) may be determined according to the values of gps.entropy_continuation_enabled_flag (the second entropy continuation enabled flag), gps.inter_frame_prediction_enabled_flag (the second inter-frame prediction enabled flag), and the determination algorithm. If gps.entropy_continuation_enabled_flag (the second entropy continuation enabled flag) is false, gbh.entropy_continuation_mode (the third inter entropy continuation mode flag) does not need to be encoded and is set to 0. If gps.entropy_continuation_enabled_flag (the second entropy continuation enabled flag) is true and gps.inter_frame_prediction_enabled_flag (the second inter-frame prediction enabled flag) is false, the value of gbh.entropy_continuation_mode (the third inter entropy continuation mode flag) is determined to be 0 or 1 according to the determination algorithm. If both gps.entropy_continuation_enabled_flag (the second entropy continuation enabled flag) and gps.inter_frame_prediction_enabled_flag (the second inter-frame prediction enabled flag) are true, the value of gbh.entropy_continuation_mode is determined to be 0, 1, or 2 according to the determination algorithm.

Exemplarily, in an embodiment of the disclosure, a source of an entropy coding probability model stored for a current slice may be determined according to the value of gbh.entropy_continuation_mode. If gbh.entropy_continuation_mode is 0, an initialization process is performed on a probability model of the current slice. If the value of gbh.entropy_continuation_mode is 1, a slice is chosen from encoded slices in the current frame according to a determination process, an index value gbh.entropy_continuation_slice_id of the selected slice in the current frame is encoded, and a probability model of the selected slice is used as the probability model of the current slice. Alternatively, a final value of the probability model of the selected slice is used as an initial value of the probability model of the current slice. If the value of gbh.entropy_continuation_mode is 2, a slice is chosen from slices in a immediately previous frame according to the determination process, the index value gbh.entropy_continuation_slice_id of the selected slice in the immediately previous frame is encoded, and a probability model of the selected slice is used as the probability model of the current slice. Alternatively, a final value of the probability model of the selected slice is used as an initial value of the probability model of the current slice.

The following describes an encoding process in the second scenario.

Furthermore, in an embodiment of the disclosure, for the encoding process in the second scenario, the encoding process of the GBH-layer flag information has difference from the encoding process in the first scenario.

Furthermore, in an embodiment of the disclosure, when determining the probability model corresponding to the current processing unit according to the third flag information, if a value of the third entropy continuation enabled flag is a tenth value, an index value of the current processing unit is determined. The probability model corresponding to the current processing unit is determined according to the index value of the current processing unit.

Furthermore, in an embodiment of the disclosure, if the value of the third entropy continuation enabled flag is an eleventh value, the third inter entropy continuation mode flag is not signalled into the bitstream.

Furthermore, in some embodiments of the disclosure, when determining the probability model corresponding to the current processing unit according to the index value of the current processing unit, the third inter entropy continuation mode flag may be determined based on the index value of the current processing unit. The probability model corresponding to the current processing unit is determined according to the third inter entropy continuation mode flag.

Furthermore, in some embodiments of the disclosure, when determining the third inter entropy continuation mode flag based on the index value of the current processing unit, if the index value of the current processing unit is a twelfth value and the third inter-frame prediction enabled flag is a thirteenth value, the third inter entropy continuation mode flag is determined.

Furthermore, in some embodiments of the disclosure, if the index value of the current processing unit is not the twelfth value, the third inter entropy continuation mode flag is determined.

Furthermore, in some embodiments of the disclosure, if the index value of the current processing unit is the twelfth value and the third inter-frame prediction enabled flag is not the thirteenth value, the third inter entropy continuation mode flag is not signalled into the bitstream, and the value of the third inter entropy continuation mode flag is determined as the fourteenth value.

Exemplarily, in an embodiment of the disclosure, gbh.inter_frame_prediction_enabled_flag (the third inter-frame prediction enabled flag) and gbh.entropy_continuation_enabled_flag (the third entropy continuation enabled flag) may be determined according to the values of gps.inter_frame_prediction_enabled_flag (the second inter-frame prediction enabled flag), gps.entropy_continuation_enabled_flag (the second entropy continuation enabled flag), gps.inter_entropy_continuation_enabled_flag (the second inter entropy continuation enabled flag), gps.intra_entropy_continuation_enabled_flag (the second intra entropy continuation enabled flag), and the determination algorithm.

Exemplarily, in an embodiment of the disclosure, if gps.inter_entropy_continuation_enabled_flag (the second inter entropy continuation enabled flag) is false, gbh.inter_frame_prediction_enabled_flag (the third inter-frame prediction enabled flag) does not need to be encoded and is set to false in subsequent processes. Otherwise, the value of gbh.inter_frame_prediction_enabled_flag is determined and encoded. If gps.entropy_continuation_enabled_flag (the second entropy continuation enabled flag) is false, gbh.entropy_continuation_enabled_flag (the third entropy continuation enabled flag) does not need to be encoded and is set to false in subsequent processes. Otherwise, the value of gbh.entropy_continuation_enabled_flag is determined and encoded.

Exemplarily, in an embodiment of the disclosure, the value of gbh.entropy_continuation_mode (the third inter entropy continuation mode flag) may be determined according to the values of gps.entropy_continuation_enabled_flag (the second entropy continuation enabled flag), gps.inter_frame_prediction_enabled_flag (the second inter-frame prediction enabled flag), and the determination algorithm. If gps.entropy_continuation_enabled_flag (the second entropy continuation enabled flag) is false, gbh.entropy_continuation_mode (the third inter entropy continuation mode flag) does not need to be encoded and is set to 0. When gps.entropy_continuation_enabled_flag (the second entropy continuation enabled flag) is true and the current slice is the first slice of the current frame, if gps.inter_frame_prediction_enabled_flag (the second inter-frame prediction enabled flag) is false, gbh.entropy_continuation_mode (the third inter entropy continuation mode) does not need to be encoded and is set to 0. Otherwise, the value of gbh.entropy_continuation_mode is determined to be 0 or 1 according to the determination algorithm and encoded. When gps.entropy_continuation_enabled_flag (the second entropy continuation enabled flag) is true and the current slice is not the first slice of the current frame, the value of gbh.entropy_continuation_mode is determined to be 0 or 1 according to the determination algorithm and encoded.

Furthermore, in some embodiments of the disclosure, for the second scenario, when determining the probability model corresponding to the current processing unit according to the third inter entropy continuation mode flag, if the value of the third inter entropy continuation mode flag is the fourteenth value, the probability model corresponding to the current processing unit is initialized. If the value of the third inter entropy continuation mode flag is the seventeenth value, the probability model corresponding to the current processing unit is determined according to a probability model corresponding to a third reference unit, where the third reference unit is an immediately previous processing unit of the current processing unit. The third reference unit and the current processing unit belong to the same frame or different frames.

Exemplarily, in an embodiment of the disclosure, for the second scenario, a source of a stored value in a probability model contained in the current slice may be determined according to the value of gbh.entropy_continuation_mode. If the value of gbh.entropy_continuation_mode is 0, the initialization process is performed on the probability model of the current slice. If the value of gbh.entropy_continuation_mode is 1, a probability model of the immediately previous slice is used as the probability model of the current slice (or a final value of the probability model of the immediately previous slice is used as the initial value of the probability model of the current slice). If the current slice is the first slice of the current frame, the “immediately previous slice” refers to the last slice of the immediately previous frame, and if the current slice is not the first slice of the current frame, the “immediately previous slice” refers to a slice that belongs to the same frame as the current slice and is encoded immediately previous the current slice.

The following describes an encoding process in the third scenario.

Furthermore, in an embodiment of the disclosure, for the third scenario, the first inter-frame prediction enabled flag may be determined and signalled into the bitstream. If the value of the first inter-frame prediction enabled flag is second value, the first entropy continuation enabled flag is not signalled into the bitstream.

Furthermore, in some embodiments of the disclosure, when determining the second flag information corresponding to the current processing unit according to the first flag information, if the value of the first entropy continuation enabled flag is the first value and the value of the second inter-frame prediction enabled flag is the seventh value, the second entropy continuation enabled flag is determined.

Furthermore, in some embodiments of the disclosure, if the value of the first entropy continuation enabled flag is the third value, or the value of the second inter-frame prediction enabled flag is the eighth value, the second entropy continuation enabled flag is not signalled into the bitstream.

Furthermore, in some embodiments of the disclosure, when determining the third flag information corresponding to the current processing unit according to the second flag information, if the value of the second inter entropy continuation enabled flag is a fifteenth value, the third inter-frame prediction enabled flag is determined. If the value of the second inter entropy continuation enabled flag is the ninth value, the third inter-frame prediction enabled flag is not signalled into the bitstream.

Furthermore, in some embodiments of the disclosure, when determining the third flag information corresponding to the current processing unit according to the second flag information, if the value of the second entropy continuation enabled flag is the fifth value and the value of the second inter entropy continuation enabled flag is the fifteenth value, the third entropy continuation enabled flag is determined. If the value of the second entropy continuation enabled flag is the sixth value, or the value of the second inter entropy continuation enabled flag is the ninth value, the third entropy continuation enabled flag is not signalled into the bitstream.

Furthermore, in some embodiments of the disclosure, if the value of the third entropy continuation enabled flag is the tenth value and a value of the third inter-frame prediction enabled flag is the thirteenth value, the third inter entropy continuation mode flag is determined. The probability model corresponding to the current processing unit is determined according to the third inter entropy continuation mode flag.

Furthermore, in some embodiments of the disclosure, if the value of the third entropy continuation enabled flag is the eleventh value, or the value of the third inter-frame prediction enabled flag is a sixteenth value, the third inter entropy continuation mode flag is not signalled into the bitstream.

Exemplarily, in an embodiment of the disclosure, for the encoding process in the third scenario, when encoding the first flag information, the configuration parameters may first be read from the profile: the SPS-layer inter-frame prediction enabled flag sps.inter_frame_prediction_enabled_flag (the first inter-frame prediction enabled flag) and the SPS-layer entropy continuation enabled flag sps.entropy_continuation_enabled_flag (the first entropy continuation enabled flag). First, sps.inter_frame_prediction_enabled_flag (the first inter-frame prediction enabled flag) is encoded. If sps.inter_frame_prediction_enabled_flag (the first inter-frame prediction enabled flag) is false, sps.entropy_continuation_enabled_flag (the first entropy continuation enabled flag) does not need to be encoded and is set to false in subsequent determinations.

Exemplarily, in an embodiment of the disclosure, when encoding the second flag information, the GPS-layer inter-frame prediction enabled flag gps.inter_frame_prediction_enabled_flag and the GPS-layer entropy continuation enabled flag gps.entropy_continuation_enabled_flag in the profile may be read, and encoding is performed according to the values of SPS-layer parameters. If sps.inter_frame_prediction_enabled_flag (the first inter-frame prediction enabled flag) is false, gps.inter_frame_prediction_enabled_flag (the second inter-frame prediction enabled flag) does not need to be encoded and is set to false in subsequent processes. Otherwise, the value of gps.inter_frame_prediction_enabled_flag is encoded. If sps.entropy_continuation_enabled_flag (the first entropy continuation enabled flag) or gps.inter_frame_prediction_enabled_flag (the second entropy continuation enabled flag) is false, gps.entropy_continuation_enabled_flag (the second entropy continuation enabled flag) does not need to be encoded. Otherwise, the value of gps.entropy_continuation_enabled_flag is encoded.

Exemplarily, in an embodiment of the disclosure, when encoding the third flag information, gbh.inter_frame_prediction_enabled_flag (the third inter-frame prediction enabled flag) and gbh.entropy_continuation_enabled_flag (the third entropy continuation enabled flag) may be determined according to the values of gps.inter_frame_prediction_enabled_flag (the second inter-frame prediction enabled flag) and gps.entropy_continuation_enabled_flag (the second entropy continuation enabled flag), and the determination algorithm. If gps.inter_entropy_continuation_enabled_flag (the second inter entropy continuation enabled flag) is false, gbh.inter_frame_prediction_enabled_flag (the third inter-frame prediction enabled flag) does not need to be encoded and is set to false in subsequent processes. Otherwise, the value of gbh.inter_frame_prediction_enabled_flag is determined and encoded. If gps.entropy_continuation_enabled_flag (the second entropy continuation enabled flag) or gps.inter_entropy_continuation_enabled_flag (the second inter entropy continuation enabled flag) is false, the gbh.entropy_continuation_enabled_flag (the third entropy continuation enabled flag) does not need to be encoded and is set to false in subsequent processes. Otherwise, the value of gbh.entropy_continuation_enabled_flag is determined and encoded.

Exemplarily, in an embodiment of the disclosure, when encoding the third flag information, the value of gbh.entropy_continuation_mode (the third inter entropy continuation mode flag) may be determined according to the values of gbh.entropy_continuation_enabled_flag (the third entropy continuation enabled flag) and gbh.inter_frame_prediction_enabled_flag (the third inter-frame prediction enabled flag), and the determination algorithm. If gbh.entropy_continuation_enabled_flag is false or gbh.inter_frame_prediction_enabled_flag is false, gbh.entropy_continuation_mode does not need to be encoded and is set to 0. If both gps.entropy_continuation_enabled_flag and gbh.inter_frame_prediction_enabled_flag are true, the value of gbh.entropy_continuation_mode is determined to be 0 or 1 according to the determination algorithm and encoded.

Furthermore, in some embodiments of the disclosure, when determining the probability model corresponding to the current processing unit according to the third inter entropy continuation mode flag, if the value of the third inter entropy continuation mode flag is the fourteenth value, the probability model corresponding to the current processing unit is initialized. If the value of the third inter entropy continuation mode flag is the seventeenth value, the probability model corresponding to the current processing unit is determined according to a probability model corresponding to a fourth reference unit. The fourth reference unit is in a frame immediately previous the frame containing the current processing unit.

Exemplarily, in an embodiment of the disclosure, a source of an entropy encoding/decoding probability model stored for the current slice may be determined according to the value of gbh.entropy_continuation_mode. If the value of gbh.entropy_continuation_mode is 0, the initialization process is performed on the probability model of the current slice. If the value of gbh.entropy_continuation_mode is 1, a slice is chosen from slices in the immediately previous frame according to the determination process. The index value gbh.entropy_continuation_slice_id of the selected slice in the immediately previous frame is encoded, and a probability model of the selected slice is used as the probability model of the current slice (or a final value of the probability model of the selected slice is used as the initial value of the probability model of the current slice).

Step 204, fourth flag information corresponding to the current processing unit is determined according to the first flag information, and the fourth flag information is signalled into the bitstream. The fourth flag information is flag information corresponding to an attribute parameter set.

In an embodiment of the disclosure, after determining the first flag information corresponding to the current processing unit and signalling the first flag information into the bitstream, the fourth flag information corresponding to the current processing unit may be determined according to the first flag information, and the fourth flag information is signalled into the bitstream. The fourth flag information is the flag information corresponding to the attribute parameter set.

It should be noted that in an embodiment of the disclosure, the first flag information may be encoded first, then the second flag information is encoded, followed by the fourth flag information, then the third flag information, and finally fifth flag information.

Furthermore, in an embodiment of the disclosure, the fourth flag information may contain a fourth inter-frame prediction enabled flag, a fourth entropy continuation enabled flag, a fourth inter entropy continuation enabled flag, and a fourth intra entropy continuation enabled flag.

Furthermore, in an embodiment of the disclosure, the fourth flag information may contain the fourth inter-frame prediction enabled flag and the fourth entropy continuation enabled flag. When determining the fourth flag information corresponding to the current processing unit according to the first flag information, the fourth inter-frame prediction enabled flag may be determined according to the first inter-frame prediction enabled flag, and the fourth entropy continuation enabled flag may be determined according to the first entropy continuation enabled flag.

Furthermore, in some embodiments of the disclosure, when determining the fourth inter-frame prediction enabled flag according to the first inter-frame prediction enabled flag, if the value of the first inter-frame prediction enabled flag is the second value, the fourth inter-frame prediction enabled flag is determined.

Furthermore, in some embodiments of the disclosure, if the value of the first inter-frame prediction enabled flag is the fourth value, the fourth inter-frame prediction enabled flag is not signalled into the bitstream.

Furthermore, in some embodiments of the disclosure, when determining the fourth entropy continuation enabled flag according to the first entropy continuation enabled flag, if the value of the first entropy continuation enabled flag is the first value, the fourth entropy continuation enabled flag is determined.

Furthermore, in some embodiments of the disclosure, if the value of the first entropy continuation enabled flag is the third value, the fourth entropy continuation enabled flag is not signalled into the bitstream.

Furthermore, in some embodiments of the disclosure, if the value of the first inter-frame prediction enabled flag is the fourth value, or the value of the first entropy continuation enabled flag is the third value, the fourth inter entropy continuation enabled flag is not signalled into the bitstream.

Furthermore, in some embodiments of the disclosure, the fourth flag information further contains the fourth intra entropy continuation enabled flag. If a value of the fourth entropy continuation enabled flag is a twentieth value, the fourth intra entropy continuation enabled flag is determined. If the value of the fourth entropy continuation enabled flag is a twenty-first value, the fourth intra entropy continuation enabled flag is not signalled into the bitstream.

Furthermore, in some embodiments of the disclosure, the fourth flag information further contains the fourth inter entropy continuation enabled flag. If the value of the fourth entropy continuation enabled flag is the twentieth value and a value of the fourth inter-frame prediction enabled flag is a twenty-second value, the fourth inter entropy continuation enabled flag is determined and signalled into the bitstream. If the value of the fourth entropy continuation enabled flag is the twenty-first value, or the value of the fourth inter-frame prediction enabled flag is a twenty-third value, the fourth inter entropy continuation enabled flag is not signalled into the bitstream.

Furthermore, in some embodiments of the disclosure, the first reordering flag and the fourth entropy continuation enabled flag are used for performing verification processing.

Step 205, the fifth flag information corresponding to the current processing unit is determined according to the fourth flag information and signalled into the bitstream, and an attribute prediction value corresponding to the current processing unit is obtained according to the fifth flag information. The fifth flag information is flag information corresponding to attribute brick header information.

In an example of the disclosure, after determining the fourth flag information corresponding to the current processing unit according to the first flag information, and signalling the fifth flag information and the fourth flag information into the bitstream, the fifth flag information corresponding to the current processing unit may be determined according to the fourth flag information. The attribute prediction value corresponding to the current processing unit may be obtained according to the fifth flag information. The fifth flag information is the flag information corresponding to the attribute brick header information.

Furthermore, in an embodiment of the disclosure, the fifth flag information may contain at least a fifth inter-frame prediction enabled flag, a fifth entropy continuation enabled flag, and a fifth inter entropy continuation mode flag.

Furthermore, in an embodiment of the disclosure, the fifth inter-frame prediction enabled flag is an ABH-layer inter-frame prediction enabled flag (abh.inter_frame_prediction_enabled_flag), the fifth entropy continuation enabled flag is an ABH-layer entropy continuation enabled flag abh.entropy_continuation_enabled_flag, and the fifth inter entropy continuation mode flag is an ABH-layer inter entropy continuation mode flag.

It can be understood that in an embodiment of the disclosure, the fifth inter-frame prediction enabled flag is used for determining whether dependency between different frames is allowed in the attribute brick header information. The fifth entropy continuation enabled flag is used for determining whether a reference entropy coding probability model is allowed to be used in the attribute brick header information. The fifth inter-frame prediction enabled flag is used for determining whether a reference entropy coding probability model of a different frame is allowed to be used in the attribute brick header information. The fifth inter entropy continuation mode flag is used for determining a source of the entropy coding probability model of the current processing unit.

Furthermore, in an embodiment of the disclosure, a probability model corresponding to the attribute information of the current processing unit may be determined according to the fifth flag information, so that the attribute prediction value corresponding to the current processing unit is obtained according to the probability model corresponding to the attribute information.

Furthermore, in some embodiments of the disclosure, if the value of the fourth inter-frame prediction enabled flag is the twenty-third value, the fifth inter-frame prediction enabled flag is not signalled into the bitstream.

Furthermore, in some embodiments of the disclosure, if a value of the fourth inter entropy continuation enabled flag is a twenty-fourth value, the third inter-frame prediction enabled flag is not signalled into the bitstream.

Furthermore, in some embodiments of the disclosure, if the value of the fourth entropy continuation enabled flag is the twentieth value, the fifth entropy continuation enabled flag and the fifth inter entropy continuation mode flag are determined.

Furthermore, in some embodiments of the disclosure, if the value of the fourth entropy continuation enabled flag is the twenty-first value, the fifth entropy continuation enabled flag and the fifth inter entropy continuation mode flag are not signalled into the bitstream.

Furthermore, in some embodiments of the disclosure, the probability model corresponding to the attribute information of the current processing unit may be determined according to the fifth inter entropy continuation mode flag.

Furthermore, in some embodiments of the disclosure, for the first scenario, when determining the probability model corresponding to the attribute information of the current processing unit according to the fifth inter entropy continuation mode flag, if a value of the fifth inter entropy continuation mode flag is a twenty-eighth value, the probability model corresponding to the attribute information of the current processing unit is initialized. If the value of the fifth inter entropy continuation mode flag is a twenty-ninth value, the probability model corresponding to the attribute information of the current processing unit is determined according to a probability model corresponding to a fifth reference unit, where the fifth reference unit and the current processing unit belong to the same frame. If the value of the fifth inter entropy continuation mode flag is a thirtieth value, the probability model corresponding to the attribute information of the current processing unit is determined according to a probability model corresponding to a sixth reference unit, where the sixth reference unit is in a frame immediately previous a frame containing the current processing unit.

The following describes an encoding process in the second scenario.

Furthermore, in an embodiment of the disclosure, for the encoding process in the second scenario, the encoding process of ABH-layer flag information the encoding process in the first scenario.

Furthermore, in an embodiment of the disclosure, when determining the probability model corresponding to the attribute information of the current processing unit according to the fifth flag information, if a value of the fifth entropy continuation enabled flag is a twenty-sixth value, the probability model corresponding to the attribute information is determined according to the index value of the current processing unit.

Furthermore, in an embodiment of the disclosure, if the value of the fifth entropy continuation enabled flag is a twenty-seventh value, the fifth inter entropy continuation mode flag is not signalled into the bitstream.

Furthermore, in some embodiments of the disclosure, when determining the probability model corresponding to the attribute information of the current processing unit according to the index value of the current processing unit, the fifth inter entropy continuation mode flag may be determined based on the index value of the current processing unit. The probability model corresponding to the attribute information is determined according to the fifth inter entropy continuation mode flag.

Furthermore, in some embodiments of the disclosure, when determining the fifth inter entropy continuation mode flag based on the index value of the current processing unit, if the index value of the current processing unit is a twelfth value and the fifth inter-frame prediction enabled flag is a thirty-first value, the fifth inter entropy continuation mode flag is determined.

Furthermore, in some embodiments of the disclosure, if the index value of the current processing unit is not the twelfth value, the fifth inter entropy continuation mode flag is determined.

Furthermore, in some embodiments of the disclosure, if the index value of the current processing unit is the twelfth value and the fifth inter-frame prediction enabled flag is not the thirty-first value, the fifth inter entropy continuation mode flag is not signalled into the bitstream, and the value of the fifth inter entropy continuation mode flag is determined as the twenty-eighth value.

Furthermore, in some embodiments of the disclosure, for the second scenario, when determining the probability model corresponding to the attribute information of the current processing unit according to the fifth inter entropy continuation mode flag, if the value of the fifth inter entropy continuation mode flag is the twenty-eighth value, the probability model corresponding to the attribute information of the current processing unit is initialized. If the value of the fifth inter entropy continuation mode flag is a twenty-ninth value, the probability model corresponding to the current processing unit is determined according to a probability model corresponding to a seventh reference unit, where the seventh reference unit is a processing unit immediately previous to the current processing unit. The seventh reference unit and the current processing unit belong to the same frame or different frames.

The following describes an encoding process in the third scenario.

Furthermore, in an embodiment of the disclosure, for the third scenario, the first inter-frame prediction enabled flag may be determined and signalled into the bitstream. If the value of the first inter-frame prediction enabled flag is second value, the first entropy continuation enabled flag is not signalled into the bitstream.

Furthermore, in some embodiments of the disclosure, when determining the fourth flag information corresponding to the current processing unit according to the first flag information, if the value of the first entropy continuation enabled flag is the first value and the value of the fourth inter-frame prediction enabled flag is a twenty-second value, the fourth entropy continuation enabled flag is determined.

Furthermore, in some embodiments of the disclosure, if the value of the first entropy continuation enabled flag is the third value, or the value of the fourth inter-frame prediction enabled flag is the twenty-third value, the fourth entropy continuation enabled flag is not signalled into the bitstream.

Furthermore, in some embodiments of the disclosure, when determining the fifth flag information corresponding to the current processing unit according to the fourth flag information, if the value of the fourth inter entropy continuation enabled flag is a twenty-fifth value, the fifth inter-frame prediction enabled flag is determined. If the value of the fourth inter entropy continuation enabled flag is the twenty-fourth value, the fifth inter-frame prediction enabled flag is not signalled into the bitstream.

Furthermore, in some embodiments of the disclosure, when determining the fifth flag information corresponding to the current processing unit according to the fourth flag information, if the value of the fourth entropy continuation enabled flag is the twentieth value and the value of the fourth inter entropy continuation enabled flag is the twenty-fifth value, the fifth entropy continuation enabled flag is determined. If the value of the fourth entropy continuation enabled flag is the twenty-first value, or the value of the fourth inter entropy continuation enabled flag is the twenty-fourth value, the fifth entropy continuation enabled flag is not signalled into the bitstream.

Furthermore, in some embodiments of the disclosure, if the value of the fifth entropy continuation enabled flag is the twenty-sixth value and the value of the fifth inter-frame prediction enabled flag is the thirty-first value, the fifth inter entropy continuation mode flag is determined. The probability model corresponding to the attribute information of the current processing unit is determined according to the fifth inter entropy continuation mode flag.

Furthermore, in some embodiments of the disclosure, if the value of the fifth entropy continuation enabled flag is the twenty-seventh value, or the value of the fifth inter-frame prediction enabled flag is a thirty-second value, the fifth inter entropy continuation mode flag is not signalled into the bitstream.

Furthermore, in some embodiments of the disclosure, when determining the probability model corresponding to the attribute information of the current processing unit according to the fifth inter entropy continuation mode flag, if the value of the fifth inter entropy continuation mode flag is the twenty-eighth value, the probability model corresponding to the attribute information of the current processing unit is initialized. If the value of the fifth inter entropy continuation mode flag is the twenty-ninth value, the probability model corresponding to the attribute information of the current processing unit is determined according to a probability model corresponding to an eighth reference unit. The eighth reference unit is in a frame immediately previous to a frame containing the current processing unit.

Embodiments of the present disclosure provide a point cloud encoding method. At the encoder end, the first flag information corresponding to the current processing unit is determined and signalled into the bitstream. The first flag information is the flag information corresponding to the sequence parameter set. According to the first flag information, the second flag information corresponding to the current processing unit is determined and signalled into the bitstream. The second flag information is the flag information corresponding to the geometry parameter set. The probability model corresponding to the current processing unit is determined based on the second flag information, and the prediction value of the current processing unit is obtained according to the probability model. In this way, during the encoding of the current processing unit, the second flag information corresponding to the current processing unit can be controlled by determining the first flag information corresponding to the current processing unit, and the inheritance of the entropy continuation enabled flag can be clarified. Therefore, the encoding operations can be simplified and the encoding performance of the point cloud can be improved.

Based on the above embodiments, in yet another embodiment of the disclosure, based on the same inventive concept of the previous embodiments, FIG. 20 illustrates a first schematic diagram of a composition structure of an encoder. As illustrated in FIG. 20, an encoder 20 may include a first determining unit 21. The first determining unit 21 is configured to determine first flag information corresponding to a current processing unit and signal the first flag information into a bitstream. The first flag information is flag information corresponding to a sequence parameter set. The first determining unit is further configured to determine second flag information corresponding to the current processing unit according to the first flag information and signal the second flag information into the bitstream. The second flag information is flag information corresponding to a geometry parameter set. The first determining unit is further configured to determine a probability model corresponding to the current processing unit based on the second flag information, and obtain a prediction value of the current processing unit according to the probability model.

It will be understood that in the embodiments, the “unit” may be part of the circuitry, part of the processor, part of the program or software, etc., and of course may also be a module, or may be non-modular. In addition, various components described in the embodiments may be integrated into one processing unit or may be present as a number of physically separated units, or two or more units may be integrated into one. The integrated units may be implemented either in the form of hardware or in the form of software function modules.

If the integrated unit is implemented as a software function module and not sold or used as a stand-alone product, the integrated unit may be stored in a computer-readable storage medium. Based on such understanding, the technical solutions of the embodiments in essential, or a part that contributes to the prior art, or all or part of the technical solutions, may be embodied in the form of a software product. The computer software product is stored in a storage medium and includes a number of instructions to enable a computer device (which may be a personal computer, a server, or a network device, etc.) or processor to perform all or part of the operations of the method described in the embodiments. The aforementioned storage medium includes a USB stick, a removable hard disk, a read only memory (ROM), a random access memory (RAM), a diskette or a CD-ROM, and other media that may store program codes.

Therefore, embodiments of the disclosure provide a computer-readable storage medium, which is applied to the encoder 20. The computer-readable storage medium stores a computer program, and when the computer program is executed by a first processor, the method described in any one of the previous embodiments is implemented.

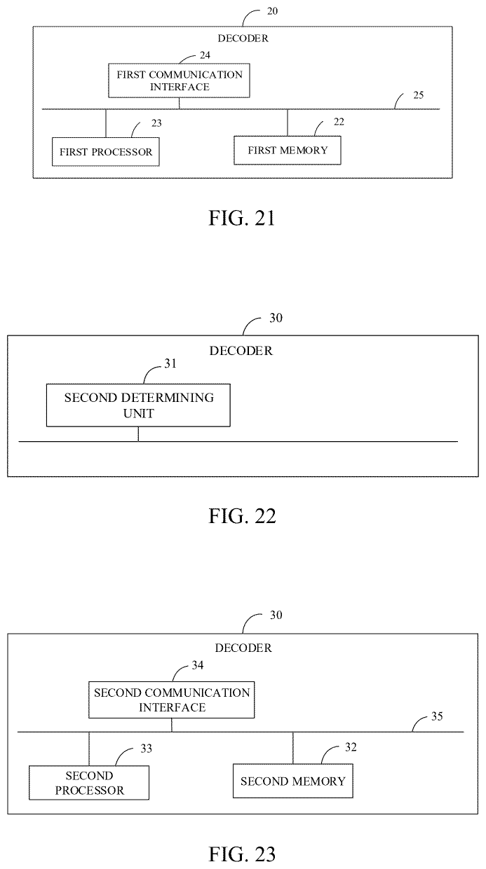

Based on the above structure of the encoder 20 and the computer-readable storage medium, FIG. 21 illustrates a second schematic diagram of a composition structure of an encoder. As illustrated in FIG. 21, the encoder 20 may include a first memory 22, a first processor 23, a first communication interface 24, and a first bus system 25. The first memory 22, the first processor 23, and the first communication interface 24 are coupled together via the first bus system 25. It can be understood that the first bus system 25 is configured to enable connection communication between these components. The first bus system 25 includes a power bus, a control bus, and a status signal bus in addition to a data bus. For the sake of clarity, however, the various buses are labelled as the first bus system 25 in FIG. 21. The first communication interface 24 is configured to receive and transmit signals during information transmission with other external network elements. The first memory 22 is configured to store a computer program executable by the first processor. The first processor 23 is configured to determine the first flag information corresponding to the current processing unit and signal the first flag information into the bitstream. The first flag information is the flag information corresponding to the sequence parameter set. The first processor 23 is further configured to determine the second flag information corresponding to the current processing unit according to the first flag information and signal the second flag information into the bitstream. The second flag information is the flag information corresponding to the geometry parameter set. The first processor 23 is further configured to determine the probability model corresponding to the current processing unit based on the second flag information, and obtain the prediction value of the current processing unit according to the probability model.

It will be appreciated that the first memory 22 in embodiments of the disclosure may be a transitory memory or non-transitory memory, or may include both transitory and non-transitory memory. In particular, the non-transitory memory may be a read-only memory (ROM), a programmable ROM (PROM), an erasable PROM (EPROM), an electrically EPROM

(EEPROM), or a flash memory. The transitory memory may be a random access memory (RAM), which is used as an external cache. By way of illustration, but not limitation, many forms of RAM are available, such as a static RAM (SRAM), a dynamic RAM (DRAM), a synchronous DRAM (SDRAM), a double data rate synchronous random access memory (DDRSDRAM), an enhanced SDRAM (ESDRAM), a synchlink DRAM (SLDRAM), and a direct rambus RAM (DRRAM). The first memory 22 of the system and method described in this disclosure is intended to include, but is not limited to, these and any other suitable types of memory.

The first processor 23 may be an integrated circuit chip with signal processing capabilities. In implementation, the operations in the above method may be accomplished by integrated logic circuitry in the hardware of the first processor 23 or by instructions in the form of software. The first processor 23 described above may be a general purpose processor, a digital signal processor (DSP), an application specific integrated circuit (ASIC), a field programmable gate array (FPGA), or other programmable logic device, discrete gate or transistor logic device, discrete hardware component. The various methods, steps and logic block diagrams disclosed in embodiments of the disclosure may be implemented or performed. The general purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the first memory 22 and the first processor 23 reads the information in the first memory 22 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSP Device (DSPD), programmable logic device (PLD), FPGA, general purpose processor, controller, microcontroller, microprocessor, other electronic unit for performing the functions described in this disclosure, or a combination thereof. For software implementations, the technology described in this disclosure may be implemented by means of modules (e.g, procedures, functions, etc.) that perform the functions described in this disclosure. The software code may be stored in a memory and executed by a processor. The memory may be implemented in the processor or outside the processor.

Optionally, as another embodiment, the first processor 23 is further configured to perform the method described in any of the above embodiments when running the computer program.

FIG. 22 illustrates a first schematic diagram of a composition structure of a decoder. As illustrated in FIG. 22, a decoder 30 may include a second determining unit 31. The second determining unit 31 is configured to determine the first flag information corresponding to the current processing unit and signal the first flag information into the bitstream. The first flag information is the flag information corresponding to the sequence parameter set. The second determining unit 31 is further configured to determine the second flag information corresponding to the current processing unit according to the first flag information and signal the second flag information into the bitstream. The second flag information is the flag information corresponding to the geometry parameter set. The second determining unit 31 is further configured to determine the probability model corresponding to the current processing unit based on the second flag information, and obtain the prediction value of the current processing unit according to the probability model.

It will be understood that in the embodiments, the “unit” may be part of the circuitry, part of the processor, part of the program or software, etc., and of course may also be a module, or may be non-modular. In addition, various components described in the embodiments may be integrated into one processing unit or may be present as a number of physically separated units, or two or more units may be integrated into one. The integrated units may be implemented either in the form of hardware or in the form of software function modules.

If the integrated unit is implemented as a software function module and not sold or used as a stand-alone product, the integrated unit may be stored in a computer-readable storage medium. Based on such understanding, the technical solutions of the embodiments in essential, or a part that contributes to the prior art, or all or part of the technical solutions, may be embodied in the form of a software product. The computer software product is stored in a storage medium and includes a number of instructions to enable a computer device (which may be a personal computer, a server, or a network device, etc.) or a processor to perform all or part of the operations of the method described in the embodiments. The aforementioned storage medium includes a USB stick, a removable hard disk, a read only memory (ROM), a random access memory (RAM), a diskette or a CD-ROM, and other media that may store program codes.

Therefore, embodiments of the disclosure provide a computer-readable storage medium, which is applied to the decoder 30. The computer-readable storage medium stores a computer program, and when the computer program is executed by a first processor, the method described in any one of the previous embodiments is implemented.

Based on the above structure of the decoder 30 and the computer-readable storage medium, FIG. 23 illustrates a second schematic diagram of a composition structure of a decoder. As illustrated in FIG. 23, the decoder 30 may include a second memory 32, a second processor 33, a second communication interface 34, and a second bus system 35. The second memory 32, the second processor 33, and the second communication interface 34 are coupled together via the second bus system 35. It can be understood that the second bus system 35 is configured to enable connection communication between these components. The second bus system 35 includes a power bus, a control bus, and a status signal bus in addition to a data bus. For the sake of clarity, however, the various buses are labelled as the second bus system 35 in FIG. 23. The second communication interface 34 is configured to receive and transmit signals during information transmission with other external network elements. The second memory 32 is configured to store a computer program executable by the second processor. The second processor 33 is configured to determine the first flag information corresponding to the current processing unit and signal the first flag information into the bitstream. The first flag information is the flag information corresponding to the sequence parameter set. The second processor 33 is further configured to determine the second flag information corresponding to the current processing unit according to the first flag information and signal the second flag information into the bitstream. The second flag information is the flag information corresponding to the geometry parameter set. The second processor 33 is further configured to determine the probability model corresponding to the current processing unit based on the second flag information, and obtain the prediction value of the current processing unit according to the probability model.

It will be appreciated that the second memory 32 in embodiments of the disclosure may be a transitory memory or non-transitory memory, or may include both transitory and non-transitory memory. In particular, the non-transitory memory may be a ROM, a PROM, an EPROM, an EEPROM, or a flash memory. The transitory memory may be a RAM, which is used as an external cache. By way of illustration, but not limitation, many forms of RAM are available, such as a SRAM, a DRAM, a SDRAM, a DDRSDRAM), an ESDRAM, a SLDRAM, and a DRRAM. The second memory 32 of the system and method described in this disclosure is intended to include, but is not limited to, these and any other suitable types of memory.

The second processor 33 may be an integrated circuit chip with signal processing capabilities. In implementation, the operations in the above method may be accomplished by integrated logic circuitry in the hardware of the second processor 33 or by instructions in the form of software. The second processor 33 described above may be a general purpose processor, a DSP, an ASIC, a FPGA, or other programmable logic device, discrete gate or transistor logic device, discrete hardware component. The various methods, steps and logic block diagrams disclosed in embodiments of the disclosure may be implemented or performed. The general purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the second memory 32 and the second processor 33 reads the information in the second memory 32 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSPD, PLD, FPGA, general purpose processor, controller, microcontroller, microprocessor, other electronic unit for performing the functions described in this disclosure, or a combination thereof. For software implementations, the technology described in this disclosure may be implemented by means of modules (e.g, procedures, functions, etc.) that perform the functions described in this disclosure. The software code may be stored in a memory and executed by a processor. The memory may be implemented in the processor or outside the processor.

Embodiments of the disclosure provide an encoder and a decoder. In a process of encoding and decoding the current processing unit, the encoder and decoder can control the second flag information corresponding to the current processing unit by determining the first flag information corresponding to the current processing unit. Thus inheritance of entropy continuation enabled flags can be clarified. Therefore, encoding and decoding operations can be simplified and encoding and decoding performance of the point cloud can be improved.

In yet another embodiment of the disclosure, a bitstream is further provided in embodiments of the disclosure. The bitstream is generated by bit encoding according to to-be-encoded information. The to-be-encoded information includes at least the following: the first flag information corresponding to the current processing unit, the second flag information corresponding to the current processing unit, and the third flag information corresponding to the current processing unit.

It may be noted that in embodiments of the disclosure, the terms “include”, “comprise” or any other variant thereof are intended to cover non-exclusive inclusion, such that a process, method, article or apparatus comprising a range of elements includes not only those elements, but also includes other elements that are not explicitly listed or are also inherent to such a process, method, article or device. Without further limitation, an element qualified by the statement “including a . . . ” does not preclude the existence of another identical element in the process, method, article or apparatus including that element.

The above serial numbers of the embodiments of the disclosure are for descriptive purposes only and do not represent the merits of the embodiments.

The methods disclosed in the several method embodiments provided in this disclosure may be combined in any way to obtain new method embodiments without conflict.

The features disclosed in the several product embodiments provided in this disclosure may be combined in any way to obtain new product embodiments without conflict.

The features disclosed in several method or apparatus embodiments provided in this disclosure may be combined in any way to obtain new method embodiments or apparatus embodiments without conflict.

The foregoing is only a specific implementation of the present disclosure, but the scope of protection of the present disclosure is not limited thereto, and any variation or substitution readily conceivable by any person skilled in the art within the technical scope disclosed in the present disclosure shall be covered by the scope of protection of the present disclosure. Accordingly, the scope of protection of this disclosure shall be governed by the scope of protection of the stated claims.

### INDUSTRIAL APPLICABILITY

Embodiments of the disclosure provide a point cloud encoding and decoding method, an encoder, a decoder, a bitstream, and a storage medium. The decoder decodes the bitstream to determine first flag information corresponding to a current processing unit. The first flag information is flag information corresponding to a sequence parameter set. The decoder further determines second flag information corresponding to the current processing unit according to the first flag information. The second flag information is flag information corresponding to a geometry parameter set. The decoder further determines a probability model based on the second flag information, and obtains a prediction value of the current processing unit according to the probability model. The encoder determines the first flag information corresponding to the current processing unit and signals the first flag information into the bitstream. The first flag information is the flag information corresponding to the sequence parameter set. The encoder further determines the second flag information corresponding to the current processing unit according to the first flag information, and signals the second flag information into the bitstream. The second flag information is the flag information corresponding to the geometry parameter set. The encoder further determines the probability model corresponding to the current processing unit based on the second flag information, and obtains the prediction value of the current processing unit according to the probability model. That is to say, in embodiments of the disclosure, in a process of encoding and decoding the current processing unit, the second flag information corresponding to the current processing unit can be controlled by determining the first flag information corresponding to the current processing unit, and an inheritance relationship of entropy continuation enabled flags can be clarified. Therefore, encoding and decoding operations can be simplified and encoding and decoding performance of the point cloud can be improved.

What is claimed is:

1. A point cloud decoding method, applied to a decoder and comprising:
decoding a bitstream to determine first flag information corresponding to a current processing unit, wherein the first flag information is flag information corresponding to a sequence parameter set of a point cloud;
determining third flag information corresponding to the current processing unit according to the first flag information, wherein the third flag information is flag information corresponding to geometry brick header information;
determining a probability model corresponding to the current processing unit based on the third flag information; and
obtaining a prediction value of the current processing unit according to the probability model.

2. The method of claim 1, wherein the first flag information comprises one or more of:
a first inter-frame prediction enabled flag, a first intra entropy continuation enabled flag, a first inter entropy continuation enabled flag, or a first reordering flag.

3. The method of claim 2, wherein decoding the bitstream to determine the first flag information corresponding to the current processing unit comprises:
decoding the bitstream to determine the first inter-frame prediction enabled flag; and
based on a value of the first inter-frame prediction enabled flag being 1, decoding the bitstream to determine the first inter entropy continuation enabled flag.

4. The method of claim 2, wherein decoding the bitstream to determine the first flag information corresponding to the current processing unit comprises:
decoding the bitstream to determine the first intra entropy continuation enabled flag.

5. The method of claim 3, wherein decoding the bitstream to determine the first flag information corresponding to the current processing unit further comprises:
decoding the bitstream to determine the first reordering flag;
wherein based on a value of the first reordering flag being 0, a value of the first inter entropy continuation enabled flag is derived to be 0.

6. The method of claim 4, wherein decoding the bitstream to determine the first flag information corresponding to the current processing unit further comprises:
decoding the bitstream to determine the first reordering flag;
wherein based on a value of the first reordering flag being 0, a value of the first intra entropy continuation enabled flag is derived to be 0.

7. The method of claim 3, wherein the method further comprises:
decoding the bitstream to determine a second inter-frame prediction enabled flag corresponding to the current processing unit; and
determining a third inter-frame prediction enabled flag corresponding to the current processing unit according to the second inter-frame prediction enabled flag;
wherein determining the third flag information corresponding to the current processing unit according to the first flag information comprises:
determining a third inter entropy continuation mode flag corresponding to the current processing unit according to the third inter-frame prediction enabled flag and the first inter entropy continuation enabled flag.

8. The method of claim 7, wherein determining the third inter entropy continuation mode flag corresponding to the current processing unit according to the third inter-frame prediction enabled flag and the first inter entropy continuation enabled flag comprises:
based on a value of the third inter-frame prediction enabled flag being 1 and a value of the first inter entropy continuation enabled flag being 1, decoding the bitstream to determine the third inter entropy continuation mode flag.

9. The method of claim 8, wherein determining the probability model corresponding to the current processing unit based on the third flag information comprises:
based on a value of the third inter entropy continuation mode flag being 0, initializing the probability model corresponding to the current processing unit; and
based on the value of the third inter entropy continuation mode flag being 1, determining the probability model corresponding to the current processing unit according to a probability model corresponding to a second reference unit, wherein the second reference unit is in a frame immediately previous to a frame containing the current processing unit.

10. The method of claim 4, wherein determining the third flag information corresponding to the current processing unit according to the first flag information comprises:
based on the first intra entropy continuation enabled flag being 1, decoding the bitstream to determine a third entropy continuation enabled flag corresponding to the current processing unit.

11. The method of claim 10, wherein determining the probability model corresponding to the current processing unit based on the third flag information comprises:
based on a value of the third entropy continuation enabled flag being 0, initializing the probability model corresponding to the current processing unit; and
based on the value of the third entropy continuation enabled flag being 1, decoding the bitstream to determine an index value of the current processing unit, and determining the probability model corresponding to the current processing unit according to the index value.

12. A point cloud encoding method, applied to an encoder and comprising:
determining first flag information corresponding to a current processing unit, and signalling the first flag information into a bitstream, wherein the first flag information is flag information corresponding to a sequence parameter set of a point cloud;
determining third flag information corresponding to the current processing unit according to the first flag information, and signalling the third flag information into the bitstream, wherein the third flag information is flag information corresponding to geometry brick header information;
determining a probability model corresponding to the current processing unit based on the third flag information; and
obtaining a prediction value of the current processing unit according to the probability model.

13. The method of claim 12, wherein the first flag information comprises one or more of:
a first inter-frame prediction enabled flag, a first intra entropy continuation enabled flag, a first inter entropy continuation enabled flag, or a first reordering flag.

14. The method of claim 13, wherein determining the first flag information corresponding to the current processing unit and signalling the first flag information into the bitstream comprises:
determining the first inter-frame prediction enabled flag and signalling the first inter-frame prediction enabled flag into the bitstream; and
based on a value of the first inter-frame prediction enabled flag being 1, determining the first inter entropy continuation enabled flag, and signalling the first inter entropy continuation enabled flag into the bitstream.

15. The method of claim 13, wherein determining the first flag information corresponding to the current processing unit and signalling the first flag information into the bitstream comprises:
determining the first intra entropy continuation enabled flag, and signalling the first intra entropy continuation enabled flag into the bitstream.

16. The method of claim 14, wherein determining the first flag information corresponding to the current processing unit and signalling the first flag information into the bitstream further comprises:
determining the first reordering flag, and signalling the first reordering flag into the bitstream;
wherein based on a value of the first reordering flag being 0, a value of the first inter entropy continuation enabled flag is derived to be 0.

17. The method of claim 15, wherein determining the first flag information corresponding to the current processing unit and signalling the first flag information into the bitstream further comprises:
determining the first reordering flag and signalling the first reordering flag into the bitstream;
wherein based on a value of the first reordering flag being 0, a value of the first intra entropy continuation enabled flag is derived to be 0.

18. The method of claim 14, wherein the method further comprises:
determining a second inter-frame prediction enabled flag corresponding to the current processing unit, and signalling the second inter-frame prediction enabled flag into the bitstream; and
determining a third inter-frame prediction enabled flag corresponding to the current processing unit according to the second inter-frame prediction enabled flag, and signalling the third inter-frame prediction enabled flag into the bitstream;
wherein determining the third flag information corresponding to the current processing unit according to the first flag information and signalling the third flag information into the bitstream comprises:
determining a third inter entropy continuation mode flag corresponding to the current processing unit according to the third inter-frame prediction enabled flag and the first inter entropy continuation enabled flag, and signalling the third inter entropy continuation mode flag into the bitstream.

19. The method of claim 18, wherein determining the third inter entropy continuation mode flag corresponding to the current processing unit according to the third inter-frame prediction enabled flag and the first inter entropy continuation enabled flag comprises:
based on a value of the third inter-frame prediction enabled flag being 1 and a value of the first inter entropy continuation enabled flag being 1, determining the third inter entropy continuation mode flag.

20. A decoder, comprising:
a processor; and
a memory storing a computer program which, when executed by the processor, cause the processor to:
decode a bitstream to determine first flag information corresponding to a current processing unit, wherein the first flag information is flag information corresponding to a sequence parameter set of a point cloud;
determine third flag information corresponding to the current processing unit according to the first flag information, wherein the third flag information is flag information corresponding to geometry brick header information;
determine a probability model corresponding to the current processing unit based on the third flag information; and
obtain a prediction value of the current processing unit according to the probability model.
